(19) United States
(12) Patent Application Publication
(10) Pub. No.: US 2014/0342038 A1
(43) Pub. Date: Nov. 20, 2014

(54) Processes and Compositions For Increasing The Digestibility of Cellulosic Materials

(71) Applicant: Novozymes A/S, Bagsvaerd (DK)

(72) Inventors: Derrick Lewis, Roanoke, VA (US); Prashant Iyer, Raleigh, NC (US); Lene Venke Kofod, Uggerloese (DK)

(73) Assignee: Novozymes A/S, Bagsvaerd (DK)

(21) Appl. No.: 14/356,916

(22) PCT Filed: Dec. 19, 2012
(86) PCT No.: PCT/US12/70464

§ 371 Date: May 8, 2014

Related U.S. Application Data
(60) Provisional application No. 61/577,162, filed on Dec. 19, 2011.
(60) Provisional application No. 61/684,897, filed on Aug. 20, 2012.

(51) Int. Cl. A23K 1/00; A23K 1/165; A23K 1/16

(52) U.S. Cl. CPC A23K 1/009; A23K 1/1631; A23K 1/1653
USPC 426/53

(57) ABSTRACT

A method for treatment of a cellulosic material is disclosed. More particularly, the treatment increases the digestibility of cellulosic material following microbial or biological processes.

### REFERENCE TO A DEPOSIT OF BIOLOGICAL MATERIAL

This application contains a reference to a deposit of biological material, which deposit is incorporated herein by reference.

### FIELD OF THE INVENTION

The present invention relates to a process of producing an animal feed comprising treatment of a cellulosic material which increases the digestibility of the cellulosic material. The invention also relates to compositions capable of increasing the digestibility of cellulosic materials, and/or any combination thereof, using one or more microorganisms and/or enzymes and to compositions that can be used in such processes.

### BACKGROUND OF THE INVENTION

Large amounts of grain products, mainly corn, are used in animal feed. Due to the use of crops for the production of biofuel products, such as ethanol and butanol, other energy and protein sources for animal feed are needed. One such source is natural plant based material.

A challenge exists, however, because natural plant based material, especially crop stover material, fiberous material, and/or other agricultural side streams, as well as materials traditionally used for silaging, comprise a significant amount of cellulosic material that is either indigestible or slowly/partially digestible in many biological systems, including and especially animals, and particularly ruminants such as cattle, goats, sheep giraffes, bison, moose, elk, yaks, water buffalo, deer, camels, alpacas, llamas, antelopes, pronghorns, etc. Accordingly, when ruminants are fed cellulosic plant based material, especially crop stover material, fiberous material, and other agricultural side streams a significant fraction of that treated material will not be digested or only partially digested.

U.S. Pat. No. 5,545,418 discloses an alkali-treated bagasse prepared by softening bagasse with calcium oxide together with or without sodium hydroxide while preventing the substantial decomposition of cellulose and hemicellulose, a bagasse feed and a fermented bagasse feed prepared from the alkali-treated bagasse, and their preparations and uses as well as bacteria (i.e., Lactobacillus spp.) for fermenting the alkali-treated bagasse.

Chinese Patent Application No. 101392268 discloses a pretreatment method for obtaining lignocellulose materials of a transformable substrate required in the production of bio-refinery, bio-energy, biological medicine, food processing, light chemical products, biological feedstuff and fertilizers, which adopts Basidiomycete sp. strains or flora that can selectively destroy the structure of lignocellulose to carry out continuous pretreatment of solid fermentation to various lignocellulose materials in an open condition.

U.S. Pat. No. 6,326,037 discloses a method for treating an animal selected from the group consisting of pigs, poultry and ruminants, to increase the animal's performance, which comprises administering to the animal, with its feed, a performance-increasing amount of an organism selected from the group consisting of Lactobacillus buchneri, Lactobacillus kefir, Lactobacillus parakefir, and Lactobacillus parabuchneri.

U.S. Pat. No. 7,494,675 discloses a method for producing an animal feed comprising adding a cellulosic material treated to make it more digestible by animals, and adding the treated cellulosic material with distillers dried grains or distillers dried grains with soluble.

WO 2012/027374 discloses enzymes and compositions of such enzymes to improve digestibility of animal feed.

There remains a need for providing processes that can increase the digestibility of cellulosic materials.

### SUMMARY OF THE INVENTION

In a first aspect the invention relates to a method for producing an animal feed comprising:

(a) pretreating a cellulosic material to separate and/or release cellulose, hemicellulose and/or lignin;

(b) inoculating the pretreated cellulosic material with at least one Bacillus;

(c) incubating the inoculated pretreated cellulosic material; and

(d) adding a protein source to the pretreated cellulosic material to produce the animal feed;

wherein step (d) occurs after step (a), (b) or (c) or simultaneously with step (b) or (c).

In a second aspect the invention relates to a method for producing an animal feed comprising:

(a) pretreating a cellulosic material to separate and/or release cellulose, hemicellulose and/or lignin;

(b) inoculating the pretreated cellulosic material with at least one microorganism;

(c) incubating the inoculated pretreated cellulosic material under substantially anaerobic conditions; and

(d) treating the pretreated cellulosic material with at least one enzyme; and

(e) adding a protein source to the pretreated cellulosic material to produce the animal feed;

wherein step (d) occurs after step (a), (b), (c) or (e) or simultaneously with step (b), (c) or (e) and step (e) occurs after step (a), (b), (c) or (d) or simultaneously with step (b), (c) or (d).

In a third aspect the invention relates to a method for producing an animal feed comprising:

(a) pretreating a cellulosic material to separate and/or release cellulose, hemicellulose and/or lignin;

(b) treating the pretreated cellulosic material with one or more enzymes selected from the group consisting of acetylxylan esterase, alpha-L-arabinofuranosidase, beta-glucosidase, beta-xylosidase, cellobiohydrolase, cellobiose dehydrogenase, endogalactosidase, endoglucanase, ferulic acid esterase, and xylanase at a pH of 7.5-11, e.g., a pH of 8-10; and

(c) adding a protein source to the pretreated cellulosic material to produce the animal feed, wherein step (c) occurs after step (a) or (b) or simultaneously with step (b).

The methods of the present invention increase the digestability of the cellulosic material.

In a fourth aspect, the invention relates to animal feed additives and compositions comprising the cellulosic material produced by a method of the present invention and a protein source.

In a final embodiment, the invention relates to a composition for increasing the digestibility of corn stover comprising at least one microorganism capable of inoculating a chemically treated corn stover under substantially anaerobic conditions.

### DEFINITIONS

Acetylxylan esterase: The term “acetylxylan esterase” means a carboxylesterase (EC 3.1.1.72) that catalyzes the hydrolysis of acetyl groups from polymeric xylan, acetylated xylose, acetylated glucose, alpha-napthyl acetate, and p-nitrophenyl acetate. For purposes of the present invention, acetylxylan esterase activity is determined using 0.5 mM p-nitrophenylacetate as substrate in 50 mM sodium acetate pH 5.0 containing 0.01% TWEEN™ 20 (polyoxyethylene sorbitan monolaurate). One unit of acetylxylan esterase is defined as the amount of enzyme capable of releasing 1 micromole of p-nitrophenolate anion per minute at pH 5, 25° C.

Alpha-L-arabinofuranosidase: The term “alpha-L-arabinofuranosidase” means an alpha-L-arabinofuranoside arabinofuranohydrolase (EC 3.2.1.55) that catalyzes the hydrolysis of terminal non-reducing alpha-L-arabinofuranoside residues in alpha-L-arabinosides. The enzyme acts on alpha-L-arabinofuranosides, alpha-L-arabinans containing (1,3)- and/or (1,5)-linkages, arabinoxylans, and arabinogalactans. Alpha-L-arabinofuranosidase is also known as arabinosidase, alpha-arabinosidase, alpha-L-arabinosidase, alpha-arabinofuranosidase, polysaccharide alpha-L-arabinofuranosidase, alpha-L-arabinofuranoside hydrolase, L-arabinosidase, or alpha-L-arabinanase. For purposes of the present invention, alpha-L-arabinofuranosidase activity is determined using 5 mg of medium viscosity wheat arabinoxylan (Megazyme International Ireland, Ltd., Bray, Co. Wicklow, Ireland) per ml of 100 mM sodium acetate pH 5 in a total volume of 200 microliters for 30 minutes at 40° C. followed by arabinose analysis by AMINEX® HPX-87H column chromatography (Bio-Rad Laboratories, Inc., Hercules, Calif., USA).

Alpha-glucuronidase: The term “alpha-glucuronidase” means an alpha-D-glucosiduronate glucuronohydrolase (EC 3.2.1.139) that catalyzes the hydrolysis of an alpha-D-glucuronoside to D-glucuronate and an alcohol. For purposes of the present invention, alpha-glucuronidase activity is determined according to de Vries, 1998, J. Bacteriol. 180: 243-249. One unit of alpha-glucuronidase equals the amount of enzyme capable of releasing 1 micromole of glucuronic or 4-O-methylglucuronic acid per minute at pH 5, 40° C.

Amylase: The term “amylase” means an enzyme that hydrolyzes 1,4-alpha-glucosidic linkages in oligosaccharides and polysaccharides, including the following classes of enzymes: alpha-amylase (EC 3.2.1.1), beta-amylase (EC 3.2.1.2), glucoamylase (EC 3.2.1.3), alpha-glucosidase (EC 3.2.1.20), G4-amylase (EC 3.2.1.60), isoamylase (EC 3.2.1.68), G6-amylase (EC 3.2.1.98), maltogenic alpha-amylase (EC 3.2.1.133), cyclodextrin glycosyltransferase (EC 2.4.1.19) and Amylase III (EC 2.4.1.161).

Beta-glucosidase: The term “beta-glucosidase” means a beta-D-glucoside glucohydrolase (E.C. 3.2.1.21) that catalyzes the hydrolysis of terminal non-reducing beta-D-glucose residues with the release of beta-D-glucose. For purposes of the present invention, beta-glucosidase activity is determined using p-nitrophenyl-beta-D-glucopyranoside as substrate according to the procedure of Venturi et al., 2002, Extracellular beta-D-glucosidase from Chaetomium thermophilum var. coprophilum: production, purification and some biochemical properties, J. Basic Microbiol. 42: 55-66. One unit of beta-glucosidase is defined as 1.0 micromole of p-nitrophenolate anion produced per minute at 25° C., pH 4.8 from 1 mM p-nitrophenyl-beta-D-glucopyranoside as substrate in 50 mM sodium citrate containing 0.01% TWEEN® 20.

Beta-xylosidase: The term “beta-xylosidase” means a beta-D-xyloside xylohydrolase (E.C. 3.2.1.37) that catalyzes the exo-hydrolysis of short beta (1→4)-xylooligosaccharides to remove successive D-xylose residues from non-reducing termini. For purposes of the present invention, one unit of beta-xylosidase is defined as 1.0 micromole of p-nitrophenolate anion produced per minute at 40° C., pH 5 from 1 mM p-nitrophenyl-beta-D-xyloside as substrate in 100 mM sodium citrate containing 0.01% TWEEN® 20.

Cellobiohydrolase: The term “cellobiohydrolase” means a 1,4-beta-D-glucan cellobiohydrolase (E.C. 3.2.1.91 and E.C. 3.2.1.176) that catalyzes the hydrolysis of 1,4-beta-D-glucosidic linkages in cellulose, cellooligosaccharides, or any beta-1,4-linked glucose containing polymer, releasing cellobiose from the reducing or non-reducing ends of the chain (Teeri, 1997, Crystalline cellulose degradation: New insight into the function of cellobiohydrolases, Trends in Biotechnology 15: 160-167; Teeri et al., 1998, Trichoderma reesei cellobiohydrolases: why so efficient on crystalline cellulose?, Biochem. Soc. Trans. 26: 173-178). Cellobiohydrolase activity is determined according to the procedures described by Lever et al., 1972, Anal. Biochem. 47: 273-279; van Tilbeurgh et al., 1982, FEBS Letters, 149: 152-156; van Tilbeurgh and Claeyssens, 1985, FEBS Letters, 187: 283-288; and Tomme et al., 1988, Eur. J. Biochem. 170: 575-581. In the present invention, the Tomme et al. method can be used to determine cellobiohydrolase activity.

Cellulolytic enzyme or cellulase: The term “cellulolytic enzyme” or “cellulase” means one or more (e.g., several) enzymes that hydrolyze a cellulosic material. Such enzymes include endoglucanase(s), cellobiohydrolase(s), beta-glucosidase(s), or combinations thereof. The two basic approaches for measuring cellulolytic activity include: (1) measuring the total cellulolytic activity, and (2) measuring the individual cellulolytic activities (endoglucanases, cellobiohydrolases, and beta-glucosidases) as reviewed in Zhang et al., Outlook for cellulase improvement: Screening and selection strategies, 2006, Biotechnology Advances 24: 452-481. Total cellulolytic activity is usually measured using insoluble substrates, including Whatman N^{o} 1 filter paper, microcrystalline cellulose, bacterial cellulose, algal cellulose, cotton, pretreated lignocellulose, etc. The most common total cellulolytic activity assay is the filter paper assay using Whatman N^{o} 1 filter paper as the substrate. The assay was established by the International Union of Pure and Applied Chemistry (IUPAC) (Ghose, 1987, Measurement of cellulase activities, Pure Appl. Chem. 59: 257-68).

For purposes of the present invention, cellulolytic enzyme activity is determined by measuring the increase in hydrolysis of a cellulosic material by cellulolytic enzyme(s) under the following conditions: 1-50 mg of cellulolytic enzyme protein/g of cellulose in PCS (or other pretreated cellulosic material) for 3-7 days at a suitable temperature, e.g., 50° C., 55° C., or 60° C., compared to a control hydrolysis without addition of cellulolytic enzyme protein. Typical conditions are 1 ml reactions, washed or unwashed PCS, 5% insoluble solids, 50 mM sodium acetate pH 5, 1 mM MnSO₄, 50° C., 55° C., or 60° C., 72 hours, sugar analysis by AMINEX® HPX-87H column (Bio-Rad Laboratories, Inc., Hercules, Calif., USA).

Cellulosic material: The term “cellulosic material” means any material containing cellulose. The predominant polysaccharide in the primary cell wall of biomass is cellulose, the second most abundant is hemicellulose, and the third is pectin. The secondary cell wall, produced after the cell has stopped growing, also contains polysaccharides and is strengthened by polymeric lignin covalently cross-linked to hemicellulose. Cellulose is a homopolymer of anhydrocellobiose and thus a linear beta-(1-4)-D-glucan, while hemicelluloses include a variety of compounds, such as xylans, xyloglucans, arabinoxylans, and mannans in complex branched structures with a spectrum of substituents. Although generally polymorphous, cellulose is found in plant tissue primarily as an insoluble crystalline matrix of parallel glucan chains. Hemicelluloses usually hydrogen bond to cellulose, as well as to other hemicelluloses, which help stabilize the cell wall matrix.

Endoglucanase: The term “endoglucanase” means an endo-1,4-(1,3;1,4)-beta-D-glucan 4-glucanohydrolase (E.C. 3.2.1.4) that catalyzes endohydrolysis of 1,4-beta-D-glycosidic linkages in cellulose, cellulose derivatives (such as carboxymethyl cellulose and hydroxyethyl cellulose), lichenin, beta-1,4 bonds in mixed beta-1,3 glucans such as cereal beta-D-glucans or xyloglucans, and other plant material containing cellulosic components. Endoglucanase activity can be determined by measuring reduction in substrate viscosity or increase in reducing ends determined by a reducing sugar assay (Zhang et al., 2006, Biotechnology Advances 24: 452-481). For purposes of the present invention, endoglucanase activity is determined using carboxymethyl cellulose (CMC) as substrate according to the procedure of Ghose, 1987, Pure and Appl. Chem. 59: 257-268, at pH 5, 40° C.

Family 61 glycoside hydrolase: The term “Family 61 glycoside hydrolase” or “Family GH61” or “GH61” means a polypeptide falling into the glycoside hydrolase Family 61 according to Henrissat, 1991, A classification of glycosyl hydrolases based on amino-acid sequence similarities, Biochem. J. 280: 309-316, and Henrissat and Bairoch, 1996, Updating the sequence-based classification of glycosyl hydrolases, Biochem. J. 316: 695-696. The enzymes in this family were originally classified as a glycoside hydrolase family based on measurement of very weak endo-1,4-beta-D-glucanase activity in one family member. The structure and mode of action of these enzymes are non-canonical and they cannot be considered as bona fide glycosidases. However, they are kept in the CAZy classification on the basis of their capacity to enhance the breakdown of lignocellulose when used in conjunction with a cellulase or a mixture of cellulases.

Feruloyl esterase: The term “feruloyl esterase” means a 4-hydroxy-3-methoxycinnamoyl-sugar hydrolase (EC 3.1.1.73) that catalyzes the hydrolysis of 4-hydroxy-3-methoxycinnamoyl (feruloyl) groups from esterified sugar, which is usually arabinose in natural biomass substrates, to produce ferulate (4-hydroxy-3-methoxycinnamate). Feruloyl esterase is also known as ferulic acid esterase, hydroxycinnamoyl esterase, FAE-III, cinnamoyl ester hydrolase, FAEA, cinnAE, FAE-I, or FAE-II. For purposes of the present invention, feruloyl esterase activity is determined using 0.5 mM p-nitrophenylferulate as substrate in 50 mM sodium acetate pH 5.0. One unit of feruloyl esterase equals the amount of enzyme capable of releasing 1 micromole of p-nitrophenolate anion per minute at pH 5, 25° C.

Hemicellulolytic enzyme or hemicellulase: The term “hemicellulolytic enzyme” or “hemicellulase” means one or more (e.g., several) enzymes that hydrolyze a hemicellulosic material. See, for example, Shallom and Shoham, 2003, Microbial hemicellulases, Current Opinion In Microbiology 6(3): 219-228). Hemicellulases are key components in the degradation of plant biomass. Examples of hemicellulases include, but are not limited to, an acetylmannan esterase, an acetylxylan esterase, an arabinanase, an arabinofuranosidase, a coumaric acid esterase, a feruloyl esterase, a galactosidase, a glucuronidase, a glucuronoyl esterase, a mannanase, a mannosidase, a xylanase, and a xylosidase. The substrates of these enzymes, hemicelluloses, are a heterogeneous group of branched and linear polysaccharides that are bound via hydrogen bonds to the cellulose microfibrils in the plant cell wall, crosslinking them into a robust network. Hemicelluloses are also covalently attached to lignin, forming together with cellulose a highly complex structure. The variable structure and organization of hemicelluloses require the concerted action of many enzymes for its complete degradation. The catalytic modules of hemicellulases are either glycoside hydrolases (GHs) that hydrolyze glycosidic bonds, or carbohydrate esterases (CEs), which hydrolyze ester linkages of acetate or ferulic acid side groups. These catalytic modules, based on homology of their primary sequence, can be assigned into GH and CE families. Some families, with an overall similar fold, can be further grouped into clans, marked alphabetically (e.g., GH-A). A most informative and updated classification of these and other carbohydrate active enzymes is available in the Carbohydrate-Active Enzymes (CAZy) database. Hemicellulolytic enzyme activities can be measured according to Ghose and Bisaria, 1987, Pure & Appl. Chem. 59: 1739-1752, at a suitable temperature, e.g., 50° C., 55° C., or 60° C., and pH, e.g., 5.0 or 5.5.

Ligninolytic enzyme: The term “ligninolytic enzyme” means an enzyme that hydrolyzes the structure of lignin polymers. Enzymes that can break down lignin include lignin peroxidases, manganese peroxidases, laccases and feruloyl esterases, and other enzymes described in the art known to depolymerize or otherwise break lignin polymers. Also included are enzymes capable of hydrolyzing bonds formed between hemicellulosic sugars (notably arabinose) and lignin.

Lipase: The term “lipase” means an enzyme that hydrolyzes lipids, fatty acids, and acylglycerides, including phosphoglycerides, lipoproteins, diacylglycerols, and the like. In plants, lipids are used as structural components to limit water loss and pathogen infection. These lipids include waxes derived from fatty acids, as well as cutin and suberin. Lipases include the following classes of enzymes: triacylglycerol lipase (EC 3.1.1.3), phospholipase A2 (EC 3.1.1.4), lysophospholipase (EC 3.1.1.5), acylglycerol lipase (EC 3.1.1.23), galactolipase (EC 3.1.1.26), phospholipase A1 (EC 3.1.1.32), dihydrocoumarin lipase (EC 3.1.1.35), 2-acetyl-1-alkylglycerophosphocholine esterase (EC 3.1.1.47), phosphatidylinositol deacylase (EC 3.1.1.52), cutinase (EC 3.1.1.74), phospholipase C (EC 3.1.4.3), phospholipase D (EC 3.1.4.4), 1-phosphatidylinositol phosphodiesterase (EC 3.1.4.10), and alkylglycerophospho ethanolamine phosphdiesterase (EC 3.1.4.39).

Microorganism: The term “microorganism” refers to any organism, including bacterial and fungal organisms, including yeast and filamentous fungi, suitable for increasing the digestibility of cellulosic material. Examples of microorganisms include bacterial organisms, such bacteria from the genus Bacillus spp. and fungal organisms, such as yeast.

Polypeptide having cellulolytic enhancing activity: The term “polypeptide having cellulolytic enhancing activity” means a GH61 polypeptide that catalyzes the enhancement of the hydrolysis of a cellulosic material by enzyme having cellulolytic activity. For purposes of the present invention, cellulolytic enhancing activity is determined by measuring the increase in reducing sugars or the increase of the total of cellobiose and glucose from the hydrolysis of a cellulosic material by a cellulolytic enzyme under the following conditions: 1-50 mg of total protein/g of cellulose in PCS, wherein total protein is comprised of 50-99.5% w/w cellulolytic enzyme protein and 0.5-50% w/w protein of a GH61 polypeptide having cellulolytic enhancing activity for 1-7 days at a suitable temperature, e.g., 50° C., 55° C., or 60° C., and pH, e.g., 5.0 or 5.5, compared to a control hydrolysis with equal total protein loading without cellulolytic enhancing activity (1-50 mg of cellulolytic protein/g of cellulose in PCS). In an embodiment, a mixture of CELLUCLAST® 1.5L (Novozymes NS, Bagsvrd, Denmark) in the presence of 2-3% of total protein weight Aspergillus oryzae beta-glucosidase (recombinantly produced in Aspergillus oryzae according to WO 02/095014) or 2-3% of total protein weight Aspergillus fumigatus beta-glucosidase (recombinantly produced in Aspergillus oryzae as described in WO 02/095014) of cellulase protein loading is used as the source of the cellulolytic activity.

The GH61 polypeptides having cellulolytic enhancing activity enhance the hydrolysis of a cellulosic material catalyzed by an enzyme having cellulolytic activity by reducing the amount of the cellulolytic enzyme required to reach the same degree of hydrolysis, e.g., at least 1.01-fold, e.g., at least 1.05-fold, at least 1.10-fold, at least 1.25-fold, at least 1.5-fold, at least 2-fold, at least 3-fold, at least 4-fold, at least 5-fold, at least 10-fold, or at least 20-fold.

Pretreated corn stover: The term “PCS” or “Pretreated Corn Stover” means a cellulosic material derived from corn stover by treatment with heat and dilute sulfuric acid, alkaline pretreatment, or neutral pretreatment.

Protease: The term “protease” means an enzyme that hydrolyzes peptide bonds (peptidases), as well as enzymes that hydrolyze bonds between peptides and other moieties, such as sugars (glycopeptidases). Many proteases are characterized under EC 3.4, and are incorporated herein by reference. Some specific types of proteases include cysteine proteases including pepsin, papain and serine proteases including chymotrypsins, carboxypeptidases and metalloendopeptidases.

Xylan-containing material: The term “xylan-containing material” means any material comprising a plant cell wall polysaccharide containing a backbone of beta-(1-4)-linked xylose residues. Xylans of terrestrial plants are heteropolymers possessing a beta-(1-4)-D-xylopyranose backbone, which is branched by short carbohydrate chains. They comprise D-glucuronic acid or its 4-O-methyl ether, L-arabinose, and/or various oligosaccharides, composed of D-xylose, L-arabinose, D- or L-galactose, and D-glucose. Xylan-type polysaccharides can be divided into homoxylans and heteroxylans, which include glucuronoxylans, (arabino)glucuronoxylans, (glucurono)arabinoxylans, arabinoxylans, and complex heteroxylans. See, for example, Ebringerova et al., 2005, Adv. Polym. Sci. 186: 1-67.

In the processes of the present invention, any material containing xylan may be used. In an embodiment, the xylan-containing material is lignocellulose.

Xylan degrading activity or xylanolytic activity: The term “xylan degrading activity” or “xylanolytic activity” means a biological activity that hydrolyzes xylan-containing material. The two basic approaches for measuring xylanolytic activity include: (1) measuring the total xylanolytic activity, and (2) measuring the individual xylanolytic activities (e.g., endoxylanases, beta-xylosidases, arabinofuranosidases, alpha-glucuronidases, acetylxylan esterases, feruloyl esterases, and alpha-glucuronyl esterases). Recent progress in assays of xylanolytic enzymes was summarized in several publications including Biely and Puchard, 2006, Recent progress in the assays of xylanolytic enzymes, Journal of the Science of Food and Agriculture 86(11): 1636-1647; Spanikova and Biely, 2006, Glucuronoyl esterase-Novel carbohydrate esterase produced by Schizophyllum commune, FEBS Letters 580(19): 4597-4601; Herrmann et al., 1997, The beta-D-xylosidase of Trichoderma reesei is a multifunctional beta-D-xylan xylohydrolase, Biochemical Journal 321: 375-381.

Total xylan degrading activity can be measured by determining the reducing sugars formed from various types of xylan, including, for example, oat spelt, beechwood, and larchwood xylans, or by photometric determination of dyed xylan fragments released from various covalently dyed xylans. The most common total xylanolytic activity assay is based on production of reducing sugars from polymeric 4-O-methyl glucuronoxylan as described in Bailey et al., 1992, Interlaboratory testing of methods for assay of xylanase activity, Journal of Biotechnology 23(3): 257-270. Xylanase activity can also be determined with 0.2% AZCL-arabinoxylan as substrate in 0.01% TRITON® X-100 (4-(1,1,3,3-tetramethylbutyl)phenyl-polyethylene glycol) and 200 mM sodium phosphate buffer pH 6 at 37° C. One unit of xylanase activity is defined as 1.0 micromole of azurine produced per minute at 37° C., pH 6 from 0.2% AZCL-arabinoxylan as substrate in 200 mM sodium phosphate pH 6 buffer.

For purposes of the present invention, xylan degrading activity is determined by measuring the increase in hydrolysis of birchwood xylan (Sigma Chemical Co., Inc., St. Louis, Mo., USA) by xylan-degrading enzyme(s) under the following typical conditions: 1 ml reactions, 5 mg/ml substrate (total solids), 5 mg of xylanolytic protein/g of substrate, 50 mM sodium acetate pH 5, 50° C., 24 hours, sugar analysis using p-hydroxybenzoic acid hydrazide (PHBAH) assay as described by Lever, 1972, A new reaction for colorimetric determination of carbohydrates, Anal. Biochem. 47: 273-279.

Xylanase: The term “xylanase” means a 1,4-beta-D-xylan-xylohydrolase (E.C. 3.2.1.8) that catalyzes the endohydrolysis of 1,4-beta-D-xylosidic linkages in xylans. For purposes of the present invention, xylanase activity is determined with 0.2% AZCL-arabinoxylan as substrate in 0.01% TRITON® X-100 and 200 mM sodium phosphate buffer pH 6 at 37° C. One unit of xylanase activity is defined as 1.0 micromole of azurine produced per minute at 37° C., pH 6 from 0.2% AZCL-arabinoxylan as substrate in 200 mM sodium phosphate pH 6 buffer.

### DETAILED DESCRIPTION OF THE INVENTION

The present invention relates to methods of producing an animal feed from a cellulosic material. The invention also relates to compositions capable of increasing the digestibility of cellulosic materials using one or more microorganisms and/or one or more enzymes.

### Cellulosic Materials

The cellulosic material may be any material comprising cellulosic fibers. Examples of such materials include, but are not limited to, wood, straw, hay, grass, silage, such as cereal silage, corn silage, grass silage; bagasse, etc. A suitable material comprising cellulosic fibers is crop stover, e.g., corn stover. Cellulose is generally found, for example, in the stems, leaves, hulls, husks, and cobs of plants or leaves, branches, and wood of trees. The cellulosic material can be, but is not limited to, agricultural residue, herbaceous material (including energy crops), municipal solid waste, pulp and paper mill residue, waste paper, and wood (including forestry residue) (see, for example, Wiselogel et al., 1995, in Handbook on Bioethanol (Charles E. Wyman, editor), pp. 105-118, Taylor & Francis, Washington D.C.; Wyman, 1994, Bioresource Technology 50: 3-16; Lynd, 1990, Applied Biochemistry and Biotechnology 24/25: 695-719; Mosier et al., 1999, Recent Progress in Bioconversion of Lignocellulosics, in Advances in Biochemical Engineering/Biotechnology, T. Scheper, managing editor, Volume 65, pp. 23-40, Springer-Verlag, New York). In an embodiment, the cellulosic material is any biomass material. In another aspect, the cellulosic material is lignocellulose, a plant cell wall material containing lignin, cellulose, and hemicellulose in a mixed matrix. Lignocellulosic-containing material is generally found, for example, in the stems, leaves, hulls, husks, and cobs of plants or leaves, branches, and wood of trees. Lignocellulosic material can also be, but is not limited to, herbaceous material, agricultural side streams (e.g., corn stover, corn fiber, soybean stover, soybean fiber, rice straw, pine wood, wood chips, poplar, wheat straw, switchgrass, bagasse, etc.), materials traditionally used for silaging (e.g., green chopped whole corn, hay, alfalfa, etc.), forestry residues, municipal solid wastes, waste paper, and pulp and paper mill residues.

In one aspect, the cellulosic material is an agricultural residue. In another aspect, the cellulosic material is herbaceous material (including energy crops). In another aspect, the cellulosic material is municipal solid waste. In another aspect, the cellulosic material is pulp and paper mill residue. In another aspect, the cellulosic material is waste paper. In another aspect, the cellulosic material is wood (including forestry residue).

In another aspect, the cellulosic material is arundo. In another aspect, the cellulosic material is bagasse. In another aspect, the cellulosic material is bamboo. In another aspect, the cellulosic material is corn cob. In another aspect, the cellulosic material is corn fiber. In another aspect, the cellulosic material is corn stover. In another aspect, the cellulosic material is miscanthus. In another aspect, the cellulosic material is orange peel. In another aspect, the cellulosic material is rice straw. In another aspect, the cellulosic material is switchgrass. In another aspect, the cellulosic material is wheat straw.

In another aspect, the cellulosic material is aspen. In another aspect, the cellulosic material is eucalyptus. In another aspect, the cellulosic material is fir. In another aspect, the cellulosic material is pine. In another aspect, the cellulosic material is poplar. In another aspect, the cellulosic material is spruce. In another aspect, the cellulosic material is willow.

In another aspect, the cellulosic material is algal cellulose. In another aspect, the cellulosic material is bacterial cellulose. In another aspect, the cellulosic material is cotton linter. In another aspect, the cellulosic material is filter paper. In another aspect, the cellulosic material is microcrystalline cellulose. In another aspect, the cellulosic material is phosphoric-acid treated cellulose.

In another aspect, the cellulosic material is an aquatic biomass. As used herein the term “aquatic biomass” means biomass produced in an aquatic environment by a photosynthesis process. The aquatic biomass can be algae, emergent plants, floating-leaf plants, or submerged plants.

### Methods of Increasing Digestibility

The methods of the present invention increase the digestibility of a cellulosic material. In order to determine an increase in the digestibility, a cellulosic material is treated using a method of the invention, and the percent increase of digestible cellulosic material is determined and compared to the digestibility of the cellulosic material which is not treated using the same method of the invention.

The method according to the invention may be used in connection with any microbial or biological process where it is desired to achieve an increased utilization of the material comprising cellulosic fibers. The invention may be used but not limited to produce feed for live stocks.

The methods of the present invention increase the digestibility of a cellulosic material by at least 5%, e.g., at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, up to 100%. Increased digestibility of cellulosic material is measured pursuant to in vitro true digestibility (IVTD) procedures discussed below.

### Pretreatment

The first step of the methods of the present invention is to pretreat a cellulosic material to separate and/or release cellulose, hemicellulose and/or lignin. Any pretreatment process can be used to disrupt plant cell wall components of the cellulosic material (Chandra et al., 2007, Substrate pretreatment: The key to effective enzymatic hydrolysis of lignocellulosics?, Adv. Biochem. Engin./Biotechnol. 108: 67-93; Galbe and Zacchi, 2007, Pretreatment of lignocellulosic materials for efficient bioethanol production, Adv. Biochem. Engin./Biotechnol. 108: 41-65; Hendriks and Zeeman, 2009, Pretreatments to enhance the digestibility of lignocellulosic biomass, Bioresource Technology 100: 10-18; Mosier et al., 2005, Features of promising technologies for pretreatment of lignocellulosic biomass, Bioresource Technology 96: 673-686; Taherzadeh and Karimi, 2008, Pretreatment of lignocellulosic wastes to improve ethanol and biogas production: a review, Int. J. Mol. Sci. 9: 1621-1651; Yang and Wyman, 2008, Pretreatment: the key to unlocking low-cost cellulosic ethanol, Biofuels Bioproducts and Biorefining-Biofpr. 2: 26-40).

The cellulosic material can also be subjected to particle size reduction, sieving, presoaking, wetting, washing, and/or conditioning prior to pretreatment using methods known in the art.

Conventional pretreatments include, but are not limited to, heat pretreatment (with or without explosion), dilute acid pretreatment, hot water pretreatment, alkaline pretreatment, lime pretreatment, wet oxidation, wet explosion, ammonia fiber explosion, organosolv pretreatment, and biological pretreatment. Additional pretreatments include ammonia percolation, ultrasound, electroporation, microwave, supercritical CO₂, supercritical H₂O, ozone, ionic liquid, and gamma irradiation pretreatments.

### Heat Pretreatment

In heat pretreatment, the cellulosic material is heated to disrupt the plant cell wall components, including lignin, hemicellulose, and cellulose to make the cellulose and other fractions, e.g., hemicellulose, accessible to enzymes. The cellulosic material is passed to or through a reaction vessel where steam is injected to increase the temperature to the required temperature and pressure and is retained therein for the desired reaction time. Heat pretreatment is suitably performed at 140-250° C., e.g., 160-200° C. or 170-190° C., where the optimal temperature range depends on addition of a chemical catalyst. Residence time for the heat pretreatment is, e.g., 1-60 minutes, e.g., 1-30 minutes, 1-20 minutes, 3-12 minutes, or 4-10 minutes, where the optimal residence time depends on temperature range and addition of a chemical catalyst. Heat pretreatment allows for relatively high solids loadings, so that the cellulosic material is generally only moist during the pretreatment. Heat pretreatment is often combined with an explosive discharge of the material after the pretreatment, which is known as steam explosion, that is, rapid flashing to atmospheric pressure and turbulent flow of the material to increase the accessible surface area by fragmentation (Duff and Murray, 1996, Bioresource Technology 855: 1-33; Galbe and Zacchi, 2002, Appl. Microbiol. Biotechnol. 59: 618-628; U.S. Application Publication No. 2002/0164730). During heat pretreatment, hemicellulose acetyl groups are cleaved and the resulting acid autocatalyzes partial hydrolysis of the hemicellulose to monosaccharides and oligosaccharides. Lignin is removed to only a limited extent.

Chemical, Mechanical and/or Biological Pretreatment

The cellulosic material may be chemically, mechanically and/or biologically pretreated. Mechanical treatment (often referred to as physical pretreatment) may be used alone or in combination with other pretreatments.

The pretreated cellulosic material may be washed and/or detoxified before microbial and/or enzymatic treatment. This may improve the treatment of, e.g., alkaline treated cellulosic material, such as corn stover. Detoxification may be carried out in any suitable way, e.g., by steam stripping, evaporation, ion exchange, resin or charcoal treatment of the liquid fraction or by washing the pretreated material.

### Chemical Pretreatment

The term “chemical treatment” refers to any chemical pretreatment that promotes the separation and/or release of cellulose, hemicellulose, and/or lignin. Such a pretreatment can convert crystalline cellulose to amorphous cellulose. Examples of suitable chemical pretreatment processes include, for example, dilute acid pretreatment, lime pretreatment, wet oxidation, ammonia fiber/freeze explosion (AFEX), ammonia percolation (APR), ionic liquid, and organosolv pretreatments. Other suitable chemical pretreatments are treatments with calcium oxide, sodium hydroxide, ammonia, and/or a combination thereof.

A catalyst such as H₂SO₄ or SO₂ (typically 0.3 to 5% w/w) is often added prior to heat pretreatment, which decreases the time and temperature, increases the recovery, and improves enzymatic hydrolysis (Ballesteros et al., 2006, Appl. Biochem. Biotechnol. 129-132: 496-508; Varga et al., 2004, Appl. Biochem. Biotechnol. 113-116: 509-523; Sassner et al., 2006, Enzyme Microb. Technol. 39: 756-762). In dilute acid pretreatment, the cellulosic material is mixed with dilute acid, typically H₂SO₄, and water to form a slurry, heated by steam to the desired temperature, and after a residence time flashed to atmospheric pressure. The dilute acid pretreatment can be performed with a number of reactor designs, e.g., plug-flow reactors, counter-current reactors, or continuous counter-current shrinking bed reactors (Duff and Murray, 1996, supra; Schell et al., 2004, Bioresource Technology 91: 179-188; Lee et al., 1999, Adv. Biochem. Eng. Biotechnol. 65: 93-115).

Several methods of pretreatment under alkaline conditions can also be used. These alkaline pretreatments include, but are not limited to, sodium hydroxide, lime, wet oxidation, ammonia percolation (APR), and ammonia fiber/freeze explosion (AFEX).

Lime pretreatment is performed with calcium oxide or calcium hydroxide at temperatures of 85-150° C. and residence times from 1 hour to several days (Wyman et al., 2005, Bioresource Technology 96: 1959-1966; Mosier et al., 2005, Bioresource Technology 96: 673-686). WO 2006/110891, WO 2006/110899, WO 2006/110900, and WO 2006/110901 disclose pretreatment methods using ammonia.

Wet oxidation is a thermal pretreatment performed typically at 180-200° C. for 5-15 minutes with addition of an oxidative agent such as hydrogen peroxide or over-pressure of oxygen (Schmidt and Thomsen, 1998, Bioresource Technology 64: 139-151; Palonen et al., 2004, Appl. Biochem. Biotechnol. 117: 1-17; Varga et al., 2004, Biotechnol. Bioeng. 88: 567-574; Martin et al., 2006, J. Chem. Technol. Biotechnol. 81: 1669-1677). The pretreatment is performed, e.g., at 1-40% dry matter, e.g., 2-30% dry matter or 5-20% dry matter, and often the initial pH is increased by the addition of alkali such as sodium carbonate.

A modification of the wet oxidation pretreatment method, known as wet explosion (combination of wet oxidation and steam explosion) can handle dry matter up to 30%. In wet explosion, the oxidizing agent is introduced during pretreatment after a certain residence time. The pretreatment is then ended by flashing to atmospheric pressure (WO 2006/032282).

Ammonia fiber explosion (AFEX) involves treating the cellulosic material with liquid or gaseous ammonia at moderate temperatures such as 90-150° C. and high pressure such as 17-20 bar for 5-10 minutes, where the dry matter content can be as high as 60% (Gollapalli et al., 2002, Appl. Biochem. Biotechnol. 98: 23-35; Chundawat et al., 2007, Biotechnol. Bioeng. 96: 219-231; Alizadeh et al., 2005, Appl. Biochem. Biotechnol. 121: 1133-1141; Teymouri et al., 2005, Bioresource Technology 96: 2014-2018). During AFEX pretreatment cellulose and hemicelluloses remain relatively intact. Lignin-carbohydrate complexes are cleaved.

Organosolv pretreatment delignifies the cellulosic material by extraction using aqueous ethanol (40-60% ethanol) at 160-200° C. for 30-60 minutes (Pan et al., 2005, Biotechnol. Bioeng. 90: 473-481; Pan et al., 2006, Biotechnol. Bioeng. 94: 851-861; Kurabi et al., 2005, Appl. Biochem. Biotechnol. 121: 219-230). Sulphuric acid is usually added as a catalyst. In organosolv pretreatment, the majority of hemicellulose and lignin is removed.

Other examples of suitable pretreatment methods are described by Schell et al., 2003, Appl. Biochem. and Biotechnol. 105-108: 69-85, and Mosier et al., 2005, Bioresource Technology 96: 673-686, and U.S. Application Publication No. 2002/0164730.

In one aspect, the chemical pretreatment may be carried out as a dilute acid treatment, e.g., as a continuous dilute acid treatment. The acid is typically sulfuric acid, but other acids can also be used, such as acetic acid, citric acid, nitric acid, phosphoric acid, tartaric acid, succinic acid, hydrogen chloride, or mixtures thereof. Mild acid treatment is conducted in the pH range of 1-5, e.g., 1-4 or 1-2.5. In one aspect, the acid concentration is in the range from 0.01 to 10 wt. % acid, e.g., 0.05 to 5 wt. % acid or 0.1 to 2 wt. % acid. The acid is contacted with the cellulosic material and held at a temperature in the range of 140-200° C., e.g., 165-190° C., for periods ranging from 1 to 60 minutes.

In another aspect, pretreatment takes place in an aqueous slurry. In other embodiments, the cellulosic material is present during pretreatment in amounts between 10-80 wt. %, e.g., 20-70 wt. % or 30-60 wt. %, such as around 40 wt. %. The pretreated cellulosic material can be unwashed or washed using any method known in the art, e.g., washed with water.

### Mechanical Pretreatment

The term “mechanical pretreatment” or “physical pretreatment” refers to any pretreatment that promotes size reduction of particles. For example, such pretreatment can involve various types of grinding or milling (e.g., dry milling, wet milling, or vibratory ball milling).

The cellulosic material can be pretreated both physically (mechanically) and chemically. Mechanical or physical pretreatment can be coupled with steaming/steam explosion, hydrothermolysis, dilute or mild acid treatment, high temperature, high pressure treatment, irradiation (e.g., microwave irradiation), or combinations thereof. In one aspect, high pressure means pressure in the range of about 100 to about 400 psi, e.g., about 150 to about 250 psi. In another aspect, high temperature means temperatures in the range of about 100 to about 300° C., e.g., about 140 to about 200° C. In an aspect, mechanical or physical pretreatment is performed in a batch-process using a steam gun hydrolyzer system that uses high pressure and high temperature as defined above, e.g., a Sunds Hydrolyzer available from Sunds Defibrator AB, Sweden. The physical and chemical pretreatments can be carried out sequentially or simultaneously, as desired.

Accordingly, in an aspect, the cellulosic material is subjected to physical (mechanical) or chemical pretreatment, or any combination thereof, to promote the separation and/or release of cellulose, hemicellulose, and/or lignin.

### Combined Chemical and Mechanical Pretreatment

In an embodiment of the invention both chemical and mechanical pretreatments are carried out involving, for example, both dilute or mild acid pretreatment and high temperature and pressure treatment. The chemical and mechanical pretreatment may be carried out sequentially or simultaneously, as desired.

Accordingly, in an embodiment, the cellulosic material is subjected to both chemical and mechanical pretreatment to promote the separation and/or release of cellulose, hemicellulose and/or lignin.

### Biological Pretreatment

The term “biological pretreatment” refers to any biological pretreatment that promotes the separation and/or release of cellulose, hemicellulose, and/or lignin from the cellulosic material. Biological pretreatment techniques can involve applying lignin-solubilizing microorganisms and/or enzymes (see, for example, Hsu, T.-A., 1996, Pretreatment of biomass, in Handbook on Bioethanol: Production and Utilization, Wyman, C. E., ed., Taylor & Francis, Washington, D.C., 179-212; Ghosh and Singh, 1993, Physicochemical and biological treatments for enzymatic/microbial conversion of cellulosic biomass, Adv. Appl. Microbiol. 39: 295-333; McMillan, J. D., 1994, Pretreating lignocellulosic biomass: a review, in Enzymatic Conversion of Biomass for Fuels Production, Himmel, M. E., Baker, J. O., and Overend, R. P., eds., ACS Symposium Series 566, American Chemical Society, Washington, D.C., chapter 15; Gong, C. S., Cao, N. J., Du, J., and Tsao, G. T., 1999, Ethanol production from renewable resources, in Advances in Biochemical Engineering/Biotechnology, Scheper, T., ed., Springer-Verlag Berlin Heidelberg, Germany, 65: 207-241; Olsson and Hahn-Hagerdal, 1996, Fermentation of lignocellulosic hydrolysates for ethanol production, Enz. Microb. Tech. 18: 312-331; and Vallander and Eriksson, 1990, Production of ethanol from lignocellulosic materials: State of the art, Adv. Biochem. Eng./Biotechnol. 42: 63-95).

### Microbial Treatment of the Pretreated Cellulosic Material

In several aspects of the present invention, the pretreated cellulosic material is inoculated with at least one microorganism and the inoculated material is incubated with the microorganism.

The microorganisms may be selected among bacteria, yeasts or fungi, or mixtures thereof. Examples of microorganisms includes strains of the genus: Acinetobacter, Aspergillus, Bacillus, Enterobacter, Lactobacillus, Pseudomonas, and Rhodococcus, such as Acinetobacter baumanii, Aspergillus niger, Aspergillus oryzae, Bacillus amyloliquefaciens, Bacillus licheniformis, Bacillus pumilus, Bacillus subtilis, Enterobacter dissolvens, Pseudomonas asntarctica, Pseudomonas fluorescens, Pseudomonas mendocina, Pseudomonas monteilii, Pseudomonas plecoglossicida, Pseudomonas pseudoacaligenes, Pseudomonas putida, and Rhodococcus pyridinivorans, and any combinations or two or more thereof. Bacterial organisms include strains of Bacillus spp. and Lactobacillus spp. In particular, strains of Bacillus spp., include, but are not limited to, Bacillus amyloliquefaciens; Bacillus atrophaeus; Bacillus azotoformans; Bacillus brevis; Bacillus cereus; Bacillus circulans; Bacillus clausii; Bacillus coagulans; Bacillus firmus; Bacillus flexus; Bacillus fusiformis; Bacillus globisporus; Bacillus glucanolyticus; Bacillus infermus; Bacillus laevolacticus; Bacillus licheniformis; Bacillus marinus; Bacillus megaterium; Bacillus mojavensis; Bacillus mycoides; Bacillus pallidus; Bacillus parabrevis; Bacillus pasteurii; Bacillus polymyxa; Bacillus popiliae; Bacillus pumilus; Bacillus sphaericus; Bacillus subtilis; Bacillus thermoamylovorans; or Bacillus thuringiensis. In particular, strains of Lactobacillus spp., include, but are not limited to, Lactobacillus acetotolerans; Lactobacillus acidifarinaei; Lactobacillus acidipiscis; Lactobacillus acidophilus; Lactobacillus agilis; Lactobacillus algidus; Lactobacillus alimentarius; Lactobacillus amylolyticus; Lactobacillus amylophilus; Lactobacillus amylotrophicus; Lactobacillus amylovorus; Lactobacillus animalis; Lactobacillus antri; Lactobacillus apodemi; Lactobacillus aviaries; Lactobacillus bifermentans; Lactobacillus brevis; Lactobacillus buchneri; Lactobacillus camelliae; Lactobacillus casei; Lactobacillus catenaformis; Lactobacillus ceti; Lactobacillus coleohominis; Lactobacillus collinoides; Lactobacillus composti; Lactobacillus concavus; Lactobacillus coryniformis; Lactobacillus crispatus; Lactobacillus crustorum; Lactobacillus curvatus; Lactobacillus delbrueckii subsp. delbrueckii; Lactobacillus delbrueckii subsp. bulgaricus; Lactobacillus delbrueckii subsp. lactis; Lactobacillus dextrinicus; Lactobacillus diolivorans; Lactobacillus equi; Lactobacillus equigenerosi; Lactobacillus farraginis; Lactobacillus farciminis; Lactobacillus fermentum; Lactobacillus formicalis; Lactobacillus fructivorans; Lactobacillus frumenti; Lactobacillus fuchuensis; Lactobacillus gallinarum; Lactobacillus gasseri; Lactobacillus gastricus; Lactobacillus ghanensis; Lactobacillus graminis; Lactobacillus hammesii; Lactobacillus hamster; Lactobacillus harbinensis; Lactobacillus hayakitensis; Lactobacillus helveticus; Lactobacillus hilgardii; Lactobacillus homohiochii; Lactobacillus iners; Lactobacillus ingluviei; Lactobacillus intestinalis; Lactobacillus jensenii; Lactobacillus johnsonii; Lactobacillus kalixensis; Lactobacillus kefiranofaciens; Lactobacillus kefiri; Lactobacillus kimchii; Lactobacillus kitasatonis; Lactobacillus kunkeei; Lactobacillus leichmannii; Lactobacillus lindneri; Lactobacillus malefermentans; Lactobacillus mali; Lactobacillus manihotivorans; Lactobacillus mindensis; Lactobacillus mucosae; Lactobacillus murinus; Lactobacillus nagelii; Lactobacillus namurensis; Lactobacillus nantensis; Lactobacillus oligofermentans; Lactobacillus oris; Lactobacillus panis; Lactobacillus pantheris; Lactobacillus parabrevis; Lactobacillus parabuchneri; Lactobacillus paracollinoides; Lactobacillus parafarraginis; Lactobacillus parakefiri; Lactobacillus paralimentarius; Lactobacillus paraplantarum; Lactobacillus pentosus; Lactobacillus perolens; Lactobacillus plantarum; Lactobacillus pontis; Lactobacillus psittaci; Lactobacillus rennin; Lactobacillus reuteri; Lactobacillus rhamnosus; Lactobacillus rimae; Lactobacillus rogosae; Lactobacillus rossiae; Lactobacillus ruminis; Lactobacillus saerimneri; Lactobacillus sakei; Lactobacillus salivarius; Lactobacillus sanfranciscensis; Lactobacillus satsumensis; Lactobacillus secaliphilus; Lactobacillus sharpeae; Lactobacillus siliginis; Lactobacillus spicheri; Lactobacillus suebicus; Lactobacillus thailandensis; Lactobacillus ultunensis; Lactobacillus vaccinostercus; Lactobacillus vaginalis; Lactobacillus versmoldensis; Lactobacillus vini; Lactobacillus vitulinus; Lactobacillus zeae; Lactobacillus zymae.

In an embodiment, the at least one additional microorganism applied to the cellulosic material is a strain of Bacillus spp.

In an embodiment, the at least one additional microorganism applied to the cellulosic material is a strain of Lactobacillus spp.

Particular strains include strains of Bacillus selected from the group consisting of ATCC 700385, NRRL B-50136, NRRL B-50622, NRRL B-50623, NRRL B-50605, NRRL B-50621, NRRL B-50015, NRRL B-50607, NRRL B-50606, PTA-7543, PTA-7547, and/or any combination thereof, including more than two, such as, at least three of the above strains, at least four of the above strains, at least five of the above strains, at least six of the above strains at least seven of the above strains, at least eight of the above strains at least nine of the above strains, at least ten of the above strains, up to and including all of the above strains.

Yeast includes strains of Saccharomyces, in particular Saccharomyces cerevisiae or Saccharomyces uvarum; Pichia, in particular Pichia stipitis, such as Pichia stipitis CBS 5773, or Pichia pastoris; Candida, in particular Candida utilis, Candida diddensii, or Candida boidinii. Other contemplated yeast includes strains of Zymomonas; Hansenula, in particular Hansenula anomala; Klyveromyces, in particular Klyveromyces fragilis; and Schizosaccharomyces, in particular Schizosaccharomyces pombe.

The skilled person will appreciate how to determine suitable amounts of these strains in the methods of the invention, using well known techniques. In an embodiment the strains are added in amounts in the range of 1.0×10⁶ to 5.0×10⁹ CFU/g total solid of cellulosic material. In another embodiment, spray dried spores are added to cellulosic material in amounts of about 5.0×10⁷ CFU/g total solid of cellulosic material.

Incubation may be performed under anaerobic, substantially anaerobic (microaerobic), or aerobic conditions, as appropriate. Briefly, anaerobic refers to an environment devoid of oxygen, substantially anaerobic (microaerobic) refers to an environment in which the concentration of oxygen is less than air, and aerobic refers to an environment wherein the oxygen concentration is approximately equal to or greater than that of the air. Substantially anaerobic conditions include, for example, a culture, inoculation, batch fermentation and/or continuous fermentation such that the dissolved oxygen concentration in the medium remains less than 10% of saturation. Substantially anaerobic conditions further includes conditions such as silage conditions (e.g., conditions occurring in a silo, a silage heap, a bag (vacuum sealed or unsealed bag(s)), a bale (wrapped and/or unwrapped bale(s)), and/or a bunker (covered and/or uncovered bunker(s)), etc.). Substantially anaerobic conditions also includes growing, inoculating, cultivating and/or resting cells in liquid medium or on solid agar inside a sealed chamber maintained with an atmosphere of less than 1% oxygen or under silage conditions. The percent of oxygen can be maintained by, for example, sparging the culture with an N₂/CO₂ mixture or other suitable non-oxygen gas or gases. In some embodiments, the cultivation and/or inoculation is performed under anaerobic conditions or substantially anaerobic conditions.

Incubation may occur under silage conditions, including but not limited to, conditions where incubation occurs in a silo, in a silage heap, a bag (vacuum sealed or unsealed), and/or in a bale (wrapped and/or unwrapped bales) etc. Silage conditions include anaerobic or substantially anaerobic conditions as defined herein. In at least one embodiment of the invention silage conditions includes, but is not limited to, conditions occurring in a silo, a silage heap, a bag (vacuum sealed or unsealed bag(s)), a bale (wrapped and/or unwrapped bale(s)), and/or a bunker (covered and/or uncovered bunker(s)), etc.). In some embodiments as disclosed herein, silage inoculation is performed under anaerobic conditions or substantially anaerobic conditions.

The duration of this step will be decided taking into account that incubation should be continued for a sufficient length of time to ensure satisfactory digestibility of the cellulosic material. Usually fermentation is anaerobic and is continued for 1 to 30 days, e.g., from 5 to 28 days, from 10 to 25 days, in particular around 21 days. It has been found that using such an incubation period a suitable high fraction of the cellulosic material is converted into a form that is more digestible.

The temperature in this step should be selected taking into account the particular requirements of the microorganism or mixture of two or more microorganisms used according to the invention. Usually the temperature is selected in the range of 10° C. to 60° C., e.g., in the range of 15° C. to 50° C., in the range of 20° C. to 45° C., in the range of 25° C. to 40° C., in particular about 37° C.

### Enzymatic Treatment of the Pretreated Cellulosic Material

In several aspects of the present invention, the pretreated cellulosic material is treated with one or more enzymes selected from the group consisting of amylases, carbohydrases, catalases, cellulases, beta-glucanases, GH61 polypeptides having cellulolytic enhancing activity, glucuronidases, hemicellulases, laccases, ligninolytic enzymes, lipases, pectinases, peroxidases, phytases, proteases, swollenins, and/or any combination thereof, including more than two, such as, at least three of the above enzymes, at least four of the above enzymes, at least five of the above enzymes, at least six of the above enzymes, at least seven of the above enzymes, at least eight of the above enzymes, at least nine of the above enzymes up to and including all of the above enzymes.

In the enzymatic treatment step, the cellulose, hemicellulose and/or lignin in the pretreated cellulosic material is broken down. The enzymes can be added simultaneously or sequentially.

Enzymatic treatment is typically carried out in a suitable aqueous environment under conditions that can be readily determined by one skilled in the art. In one aspect, enzymatic treatment is performed under conditions suitable for the activity of the enzyme(s), i.e., optimal for the enzyme(s). The treatment can be carried out as a fed batch or continuous process where the cellulosic material is fed gradually to, for example, an enzyme containing hydrolysis solution.

The treatment is generally performed in stirred-tank reactors or fermentors under controlled pH, temperature, and mixing conditions. Suitable process time, temperature and pH conditions can readily be determined by one skilled in the art. For example, the treatment can last up to 200 hours, but is typically performed for about 12 to about 120 hours, e.g., about 16 to about 72 hours or about 24 to about 48 hours. The temperature is in the range of about 25° C. to about 70° C., e.g., about 30° C. to about 65° C., about 40° C. to about 60° C., or about 50° C. to about 55° C. The pH is in the range of about 3 to about 8, e.g., about 3.5 to about 7, about 4 to about 6, or about 5.0 to about 5.5. The dry solids content is in the range of about 5 to about 50 wt. %, e.g., about 10 to about 40 wt. % or about 20 to about 30 wt. %.

The enzyme compositions can comprise any protein useful in degrading the cellulosic material.

In one aspect, the enzyme composition comprises or further comprises one or more (e.g., several) proteins selected from the group consisting of a cellulase, an esterase, an expansin, a GH61 polypeptide having cellulolytic enhancing activity, a hemicellulase, a laccase, a ligninolytic enzyme, a pectinase, a peroxidase, a protease, and a swollenin. In another aspect, the cellulase is one or more (e.g., several) enzymes selected from the group consisting of an endoglucanase, a cellobiohydrolase, and a beta-glucosidase. In another aspect, the hemicellulase is one or more (e.g., several) enzymes selected from the group consisting of an acetylmannan esterase, an acetylxylan esterase, an arabinanase, an arabinofuranosidase, a coumaric acid esterase, a feruloyl esterase, a galactosidase, a glucuronidase, a glucuronoyl esterase, a mannanase, a mannosidase, a xylanase, and a xylosidase.

In another aspect, the enzyme composition comprises one or more (e.g., several) cellulolytic enzymes. In another aspect, the enzyme composition comprises or further comprises one or more (e.g., several) hemicellulolytic enzymes. In another aspect, the enzyme composition comprises one or more (e.g., several) cellulolytic enzymes and one or more (e.g., several) hemicellulolytic enzymes. In another aspect, the enzyme composition comprises one or more (e.g., several) enzymes selected from the group of cellulolytic enzymes and hemicellulolytic enzymes. In another aspect, the enzyme composition comprises an endoglucanase. In another aspect, the enzyme composition comprises a cellobiohydrolase. In another aspect, the enzyme composition comprises a beta-glucosidase. In another aspect, the enzyme composition comprises a polypeptide having cellulolytic enhancing activity. In another aspect, the enzyme composition comprises an endoglucanase and a polypeptide having cellulolytic enhancing activity. In another aspect, the enzyme composition comprises a cellobiohydrolase and a polypeptide having cellulolytic enhancing activity. In another aspect, the enzyme composition comprises a beta-glucosidase and a polypeptide having cellulolytic enhancing activity. In another aspect, the enzyme composition comprises an endoglucanase and a cellobiohydrolase. In another aspect, the enzyme composition comprises an endoglucanase and a beta-glucosidase. In another aspect, the enzyme composition comprises a cellobiohydrolase and a beta-glucosidase. In another aspect, the enzyme composition comprises an endoglucanase, a cellobiohydrolase, and a polypeptide having cellulolytic enhancing activity. In another aspect, the enzyme composition comprises an endoglucanase, a beta-glucosidase, and a polypeptide having cellulolytic enhancing activity. In another aspect, the enzyme composition comprises a cellobiohydrolase, a beta-glucosidase, and a polypeptide having cellulolytic enhancing activity. In another aspect, the enzyme composition comprises an endoglucanase, a cellobiohydrolase, and a beta-glucosidase. In another aspect, the enzyme composition comprises an endoglucanase, a cellobiohydrolase, a beta-glucosidase, and a polypeptide having cellulolytic enhancing activity.

In another aspect, the enzyme composition comprises an acetylmannan esterase. In another aspect, the enzyme composition comprises an acetylxylan esterase. In another aspect, the enzyme composition comprises an arabinanase (e.g., alpha-L-arabinanase). In another aspect, the enzyme composition comprises an arabinofuranosidase (e.g., alpha-L-arabinofuranosidase). In another aspect, the enzyme composition comprises a coumaric acid esterase. In another aspect, the enzyme composition comprises a feruloyl esterase. In another aspect, the enzyme composition comprises a galactosidase (e.g., alpha-galactosidase and/or beta-galactosidase). In another aspect, the enzyme composition comprises a glucuronidase (e.g., alpha-D-glucuronidase). In another aspect, the enzyme composition comprises a glucuronoyl esterase. In another aspect, the enzyme composition comprises a mannanase. In another aspect, the enzyme composition comprises a mannosidase (e.g., beta-mannosidase). In another aspect, the enzyme composition comprises a xylanase. In an embodiment, the xylanase is a Family 10 xylanase. In another aspect, the enzyme composition comprises a xylosidase (e.g., beta-xylosidase).

In another aspect, the enzyme composition comprises an esterase. In another aspect, the enzyme composition comprises an expansin. In another aspect, the enzyme composition comprises a laccase. In another aspect, the enzyme composition comprises a ligninolytic enzyme. In an embodiment, the ligninolytic enzyme is a manganese peroxidase. In another aspect, the ligninolytic enzyme is a lignin peroxidase. In another aspect, the ligninolytic enzyme is a H₂O₂-producing enzyme. In another aspect, the enzyme composition comprises a pectinase. In another aspect, the enzyme composition comprises a peroxidase. In another aspect, the enzyme composition comprises a protease. In another aspect, the enzyme composition comprises a swollenin.

In the processes of the present invention, the enzyme(s) can be added prior to or during saccharification, saccharification and fermentation, or fermentation.

One or more (e.g., several) components of the enzyme composition may be wild-type proteins, recombinant proteins, or a combination of wild-type proteins and recombinant proteins. For example, one or more (e.g., several) components may be native proteins of a cell, which is used as a host cell to express recombinantly one or more (e.g., several) other components of the enzyme composition. One or more (e.g., several) components of the enzyme composition may be produced as monocomponents, which are then combined to form the enzyme composition. The enzyme composition may be a combination of multicomponent and monocomponent protein preparations.

The enzymes used in the processes of the present invention may be in any form suitable for use, such as, for example, a fermentation broth formulation or a cell composition, a cell lysate with or without cellular debris, a semi-purified or purified enzyme preparation, or a host cell as a source of the enzymes. The enzyme composition may be a dry powder or granulate, a non-dusting granulate, a liquid, a stabilized liquid, or a stabilized protected enzyme. Liquid enzyme preparations may, for instance, be stabilized by adding stabilizers such as a sugar, a sugar alcohol or another polyol, and/or lactic acid or another organic acid according to established processes.

The optimum amounts of the enzymes depend on several factors including, but not limited to, the mixture of component cellulolytic enzymes and/or hemicellulolytic enzymes, the cellulosic material, the concentration of cellulosic material, the pretreatment(s) of the cellulosic material, temperature, time, pH, and inclusion of fermenting organism (e.g., yeast for Simultaneous Saccharification and Fermentation).

In one aspect, an effective amount of cellulolytic or hemicellulolytic enzyme to the cellulosic material is about 0.5 to about 50 mg, e.g., about 0.5 to about 40 mg, about 0.5 to about 25 mg, about 0.75 to about 20 mg, about 0.75 to about 15 mg, about 0.5 to about 10 mg, or about 2.5 to about 10 mg per g of the cellulosic material.

The polypeptides having cellulolytic enzyme activity or hemicellulolytic enzyme activity as well as other proteins/polypeptides useful in the degradation of the cellulosic material, e.g., GH61 polypeptides having cellulolytic enhancing activity, can be derived or obtained from any suitable origin, including, bacterial, fungal, yeast, plant, or mammalian origin. The term “obtained” also means herein that the enzyme may have been produced recombinantly in a host organism employing methods described herein, wherein the recombinantly produced enzyme is either native or foreign to the host organism or has a modified amino acid sequence, e.g., having one or more (e.g., several) amino acids that are deleted, inserted and/or substituted, i.e., a recombinantly produced enzyme that is a mutant and/or a fragment of a native amino acid sequence or an enzyme produced by nucleic acid shuffling processes known in the art. Encompassed within the meaning of a native enzyme are natural variants and within the meaning of a foreign enzyme are variants obtained recombinantly, such as by site-directed mutagenesis or shuffling.

Each enzyme may be a bacterial polypeptide. For example, the polypeptide may be a Gram positive bacterial polypeptide such as an Acidothermus, Bacillus, Caldicellulosiruptor, Clostridium, Enterococcus, Geobacillus, Lactobacillus, Lactococcus, Oceanobacillus, Staphylococcus, Streptococcus, Streptomyces, or Thermobifidia enzyme, or a Gram negative bacterial polypeptide such as an E. coli, Campylobacter, Flavobacterium, Fusobacterium, Helicobacter, Ilyobacter, Neisseria, Pseudomonas, Salmonella, or Ureaplasma enzyme.

In one aspect, the enzyme is a Bacillus alkalophilus, Bacillus amyloliquefaciens, Bacillus brevis, Bacillus circulans, Bacillus clausii, Bacillus coagulans, Bacillus firmus, Bacillus lautus, Bacillus lentus, Bacillus licheniformis, Bacillus megaterium, Bacillus pumilus, Bacillus stearothermophilus, Bacillus subtilis, or Bacillus thuringiensis enzyme.

In another aspect, the enzyme is a Streptococcus equisimilis, Streptococcus pyogenes, Streptococcus uberis, or Streptococcus equi subsp. Zooepidemicus enzyme.

In another aspect, the enzyme is a Streptomyces achromogenes, Streptomyces avermitilis, Streptomyces coelicolor, Streptomyces griseus, or Streptomyces lividans enzyme.

Each enzyme may also be a fungal enzyme, e.g., a yeast enzyme such as a Candida, Kluyveromyces, Pichia, Saccharomyces, Schizosaccharomyces, or Yarrowia enzyme; or a filamentous fungal enzyme such as an Acremonium, Agaricus, Alternaria, Aspergillus, Aureobasidium, Botryospaeria, Ceriporiopsis, Chaetomidium, Chrysosporium, Claviceps, Cochliobolus, Coprinopsis, Coptotermes, Corynascus, Cryphonectria, Cryptococcus, Diplodia, Exidia, Filibasidium, Fusarium, Gibberella, Holomastigotoides, Humicola, Irpex, Lentinula, Leptospaeria, Magnaporthe, Melanocarpus, Meripilus, Mucor, Myceliophthora, Neocallimastix, Neurospora, Paecilomyces, Penicillium, Phanerochaete, Piromyces, Poitrasia, Pseudoplectania, Pseudotrichonympha, Rhizomucor, Schizophyllum, Scytalidium, Talaromyces, Thermoascus, Thielavia, Tolypocladium, Trichoderma, Trichophaea, Verticillium, Volvariella, or Xylaria enzyme.

In one aspect, the enzyme is a Saccharomyces carlsbergensis, Saccharomyces cerevisiae, Saccharomyces diastaticus, Saccharomyces douglasii, Saccharomyces kluyveri, Saccharomyces norbensis, or Saccharomyces oviformis enzyme.

In another aspect, the enzyme is an Acremonium cellulolyticus, Aspergillus aculeatus, Aspergillus awamori, Aspergillus fumigatus, Aspergillus foetidus, Aspergillus japonicus, Aspergillus nidulans, Aspergillus niger, Aspergillus oryzae, Chrysosporium keratinophilum, Chrysosporium lucknowense, Chrysosporium tropicum, Chrysosporium merdarium, Chrysosporium inops, Chrysosporium pannicola, Chrysosporium queenslandicum, Chrysosporium zonatum, Fusarium bactridioides, Fusarium cerealis, Fusarium crookwellense, Fusarium culmorum, Fusarium graminearum, Fusarium graminum, Fusarium heterosporum, Fusarium negundi, Fusarium oxysporum, Fusarium reticulatum, Fusarium roseum, Fusarium sambucinum, Fusarium sarcochroum, Fusarium sporotrichioides, Fusarium sulphureum, Fusarium torulosum, Fusarium trichothecioides, Fusarium venenatum, Humicola grisea, Humicola insolens, Humicola lanuginosa, Irpex lacteus, Mucor miehei, Myceliophthora thermophila, Neurospora crassa, Penicillium funiculosum, Penicillium purpurogenum, Phanerochaete chrysosporium, Thielavia achromatica, Thielavia albomyces, Thielavia albopilosa, Thielavia australeinsis, Thielavia fimeti, Thielavia microspora, Thielavia ovispora, Thielavia peruviana, Thielavia spededonium, Thielavia setosa, Thielavia subthermophila, Thielavia terrestris, Trichoderma harzianum, Trichoderma koningii, Trichoderma longibrachiatum, Trichoderma reesei, Trichoderma viride, or Trichophaea saccata enzyme.

Chemically modified or protein engineered mutants may also be used.

One or more (e.g., several) components of the enzyme composition may be a recombinant component, i.e., produced by cloning of a DNA sequence encoding the single component and subsequent cell transformed with the DNA sequence and expressed in a host (see, for example, WO 91/17243 and WO 91/17244). The host is a heterologous host (enzyme is foreign to host), but the host may under certain conditions also be a homologous host (enzyme is native to host). Monocomponent cellulolytic proteins may also be prepared by purifying such a protein from a fermentation broth.

In one aspect, the one or more (e.g., several) cellulolytic enzymes comprise a commercial cellulolytic enzyme preparation. Examples of commercial cellulolytic enzyme preparations suitable for use in the present invention include, for example, CELLIC® CTec (Novozymes NS), CELLIC® CTec2 (Novozymes NS), CELLIC® CTec3 (Novozymes NS), CELLUCLAST™ (Novozymes NS), NOVOZYM™ 188 (Novozymes NS), CELLUZYME™ (Novozymes NS), CEREFLO™ (Novozymes NS), and ULTRAFLO™ (Novozymes NS), ACCELERASE™ (Genencor Int.), LAMINEX™ (Genencor Int.), SPEZYME™ CP (Genencor Int.), FILTRASE® NL (DSM); METHAPLUS® S/L 100 (DSM), ROHAMENT™ 7069 W (Röhm GmbH), FIBREZYME® LDI (Dyadic International, Inc.), FIBREZYME® LBR (Dyadic International, Inc.), or VISCOSTAR® 150L (Dyadic International, Inc.). The cellulase enzymes are added in amounts effective from about 0.001 to about 5.0 wt. % of solids, e.g., about 0.025 to about 4.0 wt. % of solids or about 0.005 to about 2.0 wt. % of solids.

Examples of bacterial endoglucanases that can be used in the processes of the present invention, include, but are not limited to, an Acidothermus cellulolyticus endoglucanase (WO 91/05039; WO 93/15186; U.S. Pat. No. 5,275,944; WO 96/02551; U.S. Pat. No. 5,536,655, WO 00/70031, WO 05/093050); Thermobifida fusca endoglucanase III (WO 05/093050); and Thermobifida fusca endoglucanase V (WO 05/093050).

Examples of fungal endoglucanases that can be used in the present invention, include, but are not limited to, a Trichoderma reesei endoglucanase I (Penttila et al., 1986, Gene 45: 253-263), Trichoderma reesei Cel7B endoglucanase I (GENBANK™ accession no. M15665), Trichoderma reesei endoglucanase II (Saloheimo, et al., 1988, Gene 63:11-22), Trichoderma reesei Cel5A endoglucanase II (GENBANK™ accession no. M19373), Trichoderma reesei endoglucanase III (Okada et al., 1988, Appl. Environ. Microbiol. 64: 555-563, GENBANK™ accession no. AB003694), Trichoderma reesei endoglucanase V (Saloheimo et al., 1994, Molecular Microbiology 13: 219-228, GENBANK™ accession no. Z33381), Aspergillus aculeatus endoglucanase (Ooi et al., 1990, Nucleic Acids Research 18: 5884), Aspergillus kawachii endoglucanase (Sakamoto et al., 1995, Current Genetics 27: 435-439), Erwinia carotovara endoglucanase (Saarilahti et al., 1990, Gene 90: 9-14), Fusarium oxysporum endoglucanase (GENBANK™ accession no. L29381), Humicola grisea var. thermoidea endoglucanase (GENBANK™ accession no. AB003107), Melanocarpus albomyces endoglucanase (GENBANK™ accession no. MAL515703), Neurospora crassa endoglucanase (GENBANK™ accession no. XM_{—}324477), Humicola insolens endoglucanase V, Myceliophthora thermophila CBS 117.65 endoglucanase, basidiomycete CBS 495.95 endoglucanase, basidiomycete CBS 494.95 endoglucanase, Thielavia terrestris NRRL 8126 CEL6B endoglucanase, Thielavia terrestris NRRL 8126 CEL6C endoglucanase, Thielavia terrestris NRRL 8126 CEL7C endoglucanase, Thielavia terrestris NRRL 8126 CEL7E endoglucanase, Thielavia terrestris NRRL 8126 CEL7F endoglucanase, Cladorrhinum foecundissimum ATCC 62373 CEL7A endoglucanase, and Trichoderma reesei strain No. VTT-D-80133 endoglucanase (GENBANK™ accession no. M15665).

Examples of cellobiohydrolases useful in the present invention include, but are not limited to, Aspergillus aculeatus cellobiohydrolase II (WO 2011/059740), Chaetomium thermophilum cellobiohydrolase I, Chaetomium thermophilum cellobiohydrolase II, Humicola insolens cellobiohydrolase I, Myceliophthora thermophila cellobiohydrolase II (WO 2009/042871), Thielavia hyrcanie cellobiohydrolase II (WO 2010/141325), Thielavia terrestris cellobiohydrolase II (CEL6A, WO 2006/074435), Trichoderma reesei cellobiohydrolase I, Trichoderma reesei cellobiohydrolase II, and Trichophaea saccata cellobiohydrolase II (WO 2010/057086).

Examples of beta-glucosidases useful in the present invention include, but are not limited to, beta-glucosidases from Aspergillus aculeatus (Kawaguchi et al., 1996, Gene 173: 287-288), Aspergillus fumigatus (WO 2005/047499), Aspergillus niger (Dan et al., 2000, J. Biol. Chem. 275: 4973-4980), Aspergillus oryzae (WO 02/095014), Penicillium brasilianum IBT 20888 (WO 2007/019442 and WO 2010/088387), Thielavia terrestris (WO 2011/035029), and Trichophaea saccata (WO 2007/019442).

The beta-glucosidase may be a fusion protein. In one aspect, the beta-glucosidase is an Aspergillus oryzae beta-glucosidase variant BG fusion protein (WO 2008/057637) or an Aspergillus oryzae beta-glucosidase fusion protein (WO 2008/057637).

Other useful endoglucanases, cellobiohydrolases, and beta-glucosidases are disclosed in numerous Glycosyl Hydrolase families using the classification according to Henrissat, 1991, A classification of glycosyl hydrolases based on amino-acid sequence similarities, Biochem. J. 280: 309-316, and Henrissat and Bairoch, 1996, Updating the sequence-based classification of glycosyl hydrolases, Biochem. J. 316: 695-696.

Other cellulolytic enzymes that may be used in the present invention are described in WO 98/13465, WO 98/15619, WO 98/15633, WO 99/06574, WO 99/10481, WO 99/25847, WO 99/31255, WO 02/101078, WO 03/027306, WO 03/052054, WO 03/052055, WO 03/052056, WO 03/052057, WO 03/052118, WO 2004/016760, WO 2004/043980, WO 2004/048592, WO 2005/001065, WO 2005/028636, WO 2005/093050, WO 2005/093073, WO 2006/074005, WO 2006/117432, WO 2007/071818, WO 2007/071820, WO 2008/008070, WO 2008/008793, U.S. Pat. No. 5,457,046, U.S. Pat. No. 5,648,263, and U.S. Pat. No. 5,686,593.

In the processes of the present invention, any GH61 polypeptide having cellulolytic enhancing activity can be used as a component of the enzyme composition.

Examples of GH61 polypeptides having cellulolytic enhancing activity useful in the processes of the present invention include, but are not limited to, GH61 polypeptides from Thielavia terrestris (WO 2005/074647, WO 2008/148131, and WO 2011/035027), Thermoascus aurantiacus (WO 2005/074656 and WO 2010/065830), Trichoderma reesei (WO 2007/089290), Myceliophthora thermophila (WO 2009/085935, WO 2009/085859, WO 2009/085864, WO 2009/085868), Aspergillus fumigatus (WO 2010/138754), Penicillium pinophilum (WO 2011/005867), Thermoascus sp. (WO 2011/039319), Penicillium sp. (WO 2011/041397), and Thermoascus crustaceous (WO 2011/041504).

In one aspect, the GH61 polypeptide having cellulolytic enhancing activity is used in the presence of a soluble activating divalent metal cation according to WO 2008/151043, e.g., manganese sulfate.

In another aspect, the GH61 polypeptide having cellulolytic enhancing activity is used in the presence of a dioxy compound, a bicylic compound, a heterocyclic compound, a nitrogen-containing compound, a quinone compound, a sulfur-containing compound, or a liquor obtained from a pretreated cellulosic material such as pretreated corn stover (PCS).

The dioxy compound may include any suitable compound containing two or more oxygen atoms. In some aspects, the dioxy compounds contain a substituted aryl moiety as described herein. The dioxy compounds may comprise one or more (e.g., several) hydroxyl and/or hydroxyl derivatives, but also include substituted aryl moieties lacking hydroxyl and hydroxyl derivatives. Non-limiting examples of the dioxy compounds include pyrocatechol or catechol; caffeic acid; 3,4-dihydroxybenzoic acid; 4-tert-butyl-5-methoxy-1,2-benzenediol; pyrogallol; gallic acid; methyl-3,4,5-trihydroxybenzoate; 2,3,4-trihydroxybenzophenone; 2,6-dimethoxyphenol; sinapinic acid; 3,5-dihydroxybenzoic acid; 4-chloro-1,2-benzenediol; 4-nitro-1,2-benzenediol; tannic acid; ethyl gallate; methyl glycolate; dihydroxyfumaric acid; 2-butyne-1,4-diol; croconic acid; 1,3-propanediol; tartaric acid; 2,4-pentanediol; 3-ethyoxy-1,2-propanediol; 2,4,4′-trihydroxybenzophenone; cis-2-butene-1,4-diol; 3,4-dihydroxy-3-cyclobutene-1,2-dione; dihydroxyacetone; acrolein acetal; methyl-4-hydroxybenzoate; 4-hydroxybenzoic acid; and methyl-3,5-dimethoxy-4-hydroxybenzoate; or a salt or solvate thereof.

The bicyclic compound may include any suitable substituted fused ring system as described herein. The compounds may comprise one or more (e.g., several) additional rings, and are not limited to a specific number of rings unless otherwise stated. In one aspect, the bicyclic compound is a flavonoid. In another aspect, the bicyclic compound is an optionally substituted isoflavonoid. In another aspect, the bicyclic compound is an optionally substituted flavylium ion, such as an optionally substituted anthocyanidin or optionally substituted anthocyanin, or derivative thereof. Non-limiting examples of the bicyclic compounds include epicatechin; quercetin; myricetin; taxifolin; kaempferol; morin; acacetin; naringenin; isorhamnetin; apigenin; cyanidin; cyanin; kuromanin; keracyanin; or a salt or solvate thereof.

The heterocyclic compound may be any suitable compound, such as an optionally substituted aromatic or non-aromatic ring comprising a heteroatom, as described herein. In one aspect, the heterocyclic is a compound comprising an optionally substituted heterocycloalkyl moiety or an optionally substituted heteroaryl moiety. In another aspect, the optionally substituted heterocycloalkyl moiety or optionally substituted heteroaryl moiety is an optionally substituted 5-membered heterocycloalkyl or an optionally substituted 5-membered heteroaryl moiety. In another aspect, the optionally substituted heterocycloalkyl or optionally substituted heteroaryl moiety is an optionally substituted moiety selected from pyrazolyl, furanyl, imidazolyl, isoxazolyl, oxadiazolyl, oxazolyl, pyrrolyl, pyridyl, pyrimidyl, pyridazinyl, thiazolyl, triazolyl, thienyl, dihydrothieno-pyrazolyl, thianaphthenyl, carbazolyl, benzimidazolyl, benzothienyl, benzofuranyl, indolyl, quinolinyl, benzotriazolyl, benzothiazolyl, benzooxazolyl, benzimidazolyl, isoquinolinyl, isoindolyl, acridinyl, benzoisazolyl, dimethylhydantoin, pyrazinyl, tetrahydrofuranyl, pyrrolinyl, pyrrolidinyl, morpholinyl, indolyl, diazepinyl, azepinyl, thiepinyl, piperidinyl, and oxepinyl. In another aspect, the optionally substituted heterocycloalkyl moiety or optionally substituted heteroaryl moiety is an optionally substituted furanyl. Non-limiting examples of the heterocyclic compounds include (1,2-dihydroxyethyl)-3,4-dihydroxyfuran-2(5H)-one; 4-hydroxy-5-methyl-3-furanone; 5-hydroxy-2(5H)-furanone; [1,2-dihydroxyethyl]furan-2,3,4(5H)-trione; α-hydroxy-γ-butyrolactone; ribonic γ-lactone; aldohexuronicaldohexuronic acid γ-lactone; gluconic acid 5-lactone; 4-hydroxycoumarin; dihydrobenzofuran; 5-(hydroxymethyl)furfural; furoin; 2(5H)-furanone; 5,6-dihydro-2H-pyran-2-one; and 5,6-dihydro-4-hydroxy-6-methyl-2H-pyran-2-one; or a salt or solvate thereof.

The nitrogen-containing compound may be any suitable compound with one or more nitrogen atoms. In one aspect, the nitrogen-containing compound comprises an amine, imine, hydroxylamine, or nitroxide moiety. Non-limiting examples of the nitrogen-containing compounds include acetone oxime; violuric acid; pyridine-2-aldoxime; 2-aminophenol; 1,2-benzenediamine; 2,2,6,6-tetramethyl-1-piperidinyloxy; 5,6,7,8-tetrahydrobiopterin; 6,7-dimethyl-5,6,7,8-tetrahydropterine; and maleamic acid; or a salt or solvate thereof.

The quinone compound may be any suitable compound comprising a quinone moiety as described herein. Non-limiting examples of the quinone compounds include 1,4-benzoquinone; 1,4-naphthoquinone; 2-hydroxy-1,4-naphthoquinone; 2,3-dimethoxy-5-methyl-1,4-benzoquinone or coenzyme Q₀; 2,3,5,6-tetramethyl-1,4-benzoquinone or duroquinone; 1,4-dihydroxyanthraquinone; 3-hydroxy-1-methyl-5,6-indolinedione or adrenochrome; 4-tert-butyl-5-methoxy-1,2-benzoquinone; pyrroloquinoline quinone; or a salt or solvate thereof.

The sulfur-containing compound may be any suitable compound comprising one or more sulfur atoms. In one aspect, the sulfur-containing comprises a moiety selected from thionyl, thioether, sulfinyl, sulfonyl, sulfamide, sulfonamide, sulfonic acid, and sulfonic ester. Non-limiting examples of the sulfur-containing compounds include ethanethiol; 2-propanethiol; 2-propene-1-thiol; 2-mercaptoethanesulfonic acid; benzenethiol; benzene-1,2-dithiol; cysteine; methionine; glutathione; cystine; or a salt or solvate thereof.

In one aspect, an effective amount of such a compound described above to cellulosic material as a molar ratio to glucosyl units of cellulose is about 10⁻⁶ to about 10, e.g., about 10⁻⁶ to about 7.5, about 10⁻⁶ to about 5, about 10⁻⁶ to about 2.5, about 10⁻⁶ to about 1, about 10⁻⁵ to about 1, about 10⁻⁵ to about 10⁻¹, about 10⁻⁴ to about 10⁻¹, about 10⁻³ to about 10⁻¹, or about 10⁻³ to about 10⁻². In another aspect, an effective amount of such a compound described above is about 0.1 microM to about 1 M, e.g., about 0.5 microM to about 0.75 M, about 0.75 microM to about 0.5 M, about 1 microM to about 0.25 M, about 1 microM to about 0.1 M, about 5 microM to about 50 mM, about 10 microM to about 25 mM, about 50 microM to about 25 mM, about 10 microM to about 10 mM, about 5 microM to about 5 mM, or about 0.1 mM to about 1 mM.

The term “liquor” means the solution phase, either aqueous, organic, or a combination thereof, arising from treatment of a lignocellulose and/or hemicellulose material in a slurry, or monosaccharides thereof, e.g., xylose, arabinose, mannose, etc., under conditions as described herein, and the soluble contents thereof. A liquor for cellulolytic enhancement of a GH61 polypeptide can be produced by treating a lignocellulose or hemicellulose material (or feedstock) by applying heat and/or pressure, optionally in the presence of a catalyst, e.g., acid, optionally in the presence of an organic solvent, and optionally in combination with physical disruption of the material, and then separating the solution from the residual solids. Such conditions determine the degree of cellulolytic enhancement obtainable through the combination of liquor and a GH61 polypeptide during hydrolysis of a cellulosic substrate by a cellulase preparation. The liquor can be separated from the treated material using a method standard in the art, such as filtration, sedimentation, or centrifugation.

In one aspect, an effective amount of the liquor to cellulose is about 10⁻⁶ to about 10 g per g of cellulose, e.g., about 10⁻⁶ to about 7.5 g, about 10⁻⁶ to about 5 g, about 10⁻⁶ to about 2.5 g, about 10⁻⁶ to about 1 g, about 10⁻⁵ to about 1 g, about 10⁻⁵ about 10⁻¹ g, about 10⁻⁴ to about 10⁻¹ g, about 10⁻³ to about 10⁻¹ g, or about 10⁻³ to about 10⁻² g per g of cellulose.

In one aspect, the one or more (e.g., several) hemicellulolytic enzymes comprise a commercial hemicellulolytic enzyme preparation. Examples of commercial hemicellulolytic enzyme preparations suitable for use in the present invention include, for example, SHEARZYME™ (Novozymes NS), CELLIC® HTec (Novozymes NS), CELLIC® HTec2 (Novozymes NS), CELLIC® HTec3 (Novozymes NS), VISCOZYME® (Novozymes NS), ULTRAFLO® (Novozymes NS), PULPZYME® HC (Novozymes NS), MULTIFECT® Xylanase (Genencor), ACCELLERASE® XY (Genencor), ACCELLERASE® XC (Genencor), ECOPULP® TX-200A (AB Enzymes), HSP 6000 Xylanase (DSM), DEPOL™ 333P (Biocatalysts Limit, Wales, UK), DEPOL™ 740L. (Biocatalysts Limit, Wales, UK), and DEPOL™ 762P (Biocatalysts Limit, Wales, UK).

Examples of xylanases useful in the processes of the present invention include, but are not limited to, xylanases from Aspergillus aculeatus (GeneSeqP:AAR63790; WO 94/21785), Aspergillus fumigatus (WO 2006/078256), Penicillium pinophilum (WO 2011/041405), Penicillium sp. (WO 2010/126772), Thielavia terrestris NRRL 8126 (WO 2009/079210), and Trichophaea saccata GH10 (WO 2011/057083).

Examples of beta-xylosidases useful in the processes of the present invention include, but are not limited to, beta-xylosidases from Neurospora crassa (SwissProt accession no. Q7SOW4), Trichoderma reesei (UniProtKB/TrEMBL accession no. Q92458), and Talaromyces emersonii (SwissProt accession no. Q8×212).

Examples of acetylxylan esterases useful in the processes of the present invention include, but are not limited to, acetylxylan esterases from Aspergillus aculeatus (WO 2010/108918), Chaetomium globosum (UniProt accession no. Q2GWX4), Chaetomium gracile (GeneSeqP accession no. AAB82124), Humicola insolens DSM 1800 (WO 2009/073709), Hypocrea jecorina (WO 2005/001036), Myceliophtera thermophila (WO 2010/014880), Neurospora crassa (UniProt accession no. q7s259), Phaeosphaeria nodorum (UniProt accession no. QOUHJ1), and Thielavia terrestris NRRL 8126 (WO 2009/042846).

Examples of feruloyl esterases (ferulic acid esterases) useful in the processes of the present invention include, but are not limited to, feruloyl esterases form Humicola insolens DSM 1800 (WO 2009/076122), Neosartorya fischeri (UniProt accession no. A1D9T4), Neurospora crassa (UniProt accession no. Q9HGR3), Penicillium aurantiogriseum (WO 2009/127729), and Thielavia terrestris (WO 2010/053838 and WO 2010/065448).

Examples of arabinofuranosidases useful in the processes of the present invention include, but are not limited to, arabinofuranosidases from Aspergillus niger (GeneSeqP accession no. AAR94170), Humicola insolens DSM 1800 (WO 2006/114094 and WO 2009/073383), and M. giganteus (WO 2006/114094).

Examples of alpha-glucuronidases useful in the processes of the present invention include, but are not limited to, alpha-glucuronidases from Aspergillus clavatus (UniProt accession no. alcc12), Aspergillus fumigatus (SwissProt accession no. Q4WW45), Aspergillus niger (UniProt accession no. Q96WX9), Aspergillus terreus (SwissProt accession no. Q0CJP9), Humicola insolens (WO 2010/014706), Penicillium aurantiogriseum (WO 2009/068565), Talaromyces emersonii (UniProt accession no. Q8×211), and Trichoderma reesei (UniProt accession no. Q99024).

The enzyme used in the processes of the present invention may be produced by fermentation of the above-noted microbial strains on a nutrient medium containing suitable carbon and nitrogen sources and inorganic salts, using procedures known in the art (see, e.g., Bennett, J. W. and LaSure, L. (eds.), More Gene Manipulations in Fungi, Academic Press, CA, 1991). Suitable media are available from commercial suppliers or may be prepared according to published compositions (e.g., in catalogues of the American Type Culture Collection). Temperature ranges and other conditions suitable for growth and enzyme production are known in the art (see, e.g., Bailey, J. E., and Ollis, D. F., Biochemical Engineering Fundamentals, McGraw-Hill Book Company, NY, 1986).

The fermentation can be any method of cultivation of a cell resulting in the expression or isolation of an enzyme or protein. Fermentation may, therefore, be understood as comprising shake flask cultivation, or small- or large-scale fermentation (including continuous, batch, fed-batch, or solid state fermentations) in laboratory or industrial fermentors performed in a suitable medium and under conditions allowing the enzyme to be expressed or isolated. The resulting enzymes produced by the methods described above may be recovered from the fermentation medium and purified by conventional procedures.

### Animal Feed

The present invention is also directed to animal feed compositions and feed additives comprising the treated cellulosic material and a protein source, an essential nutritional factor.

The term animal includes all animals, including human beings. Examples of animals are non-ruminants and ruminants. Ruminant animals include, for example, animals such as sheep, goats, horses, and cattle, e.g., beef cattle, cows, and young calves. In a particular embodiment, the animal is a non-ruminant animal. Non-ruminant animals include mono-gastric animals, e.g., pigs or swine (including, but not limited to, piglets, growing pigs, and sows); poultry such as turkeys, ducks and chicken (including but not limited to broiler chicks, layers); and aquatic animal species such as fish (including but not limited to salmon, trout, tilapia, catfish and carps; and crustaceans (including but not limited to shrimps and prawns).

The term feed or feed composition comprises any compound, preparation, mixture, or composition suitable for or intended for intake by an animal.

In the use according to the invention the treated cellulosic material can be fed to the animal before, after, or simultaneously with the diet. The latter is preferred.

The treated cellulosic material can be (a) added directly to the feed (or used directly in a protein treatment process), or (b) it can be used in the production of one or more intermediate compositions such as feed additives or premixes that is subsequently added to the feed (or used in a treatment process).

The animal feed additive or composition comprises a protein source, which may be an animal protein, such as meat and bone meal, and/or fish meal; or a vegetable protein.

The term vegetable proteins as used herein refers to any compound, composition, preparation or mixture that includes at least one protein derived from or originating from a vegetable, including modified proteins and protein-derivatives. In particular embodiments, the protein content of the vegetable proteins is at least 10, 20, 30, 40, 50, or 60% (w/w).

Vegetable proteins may be derived from vegetable protein sources, such as legumes and cereals, for example materials from plants of the families Fabaceae (Leguminosae), Cruciferaceae, Chenopodiaceae, and Poaceae, such as soy bean meal, lupin meal and rapeseed meal.

In a particular embodiment, the vegetable protein source is material from one or more plants of the family Fabaceae, e.g., soybean, lupine, pea, or bean.

In another particular embodiment, the vegetable protein source is material from one or more plants of the family Chenopodiaceae, e.g., beet, sugar beet, spinach or quinoa.

Other examples of vegetable protein sources are rapeseed, sunflower seed, cotton seed, and cabbage.

Soybean is a suitable vegetable protein source.

Other examples of vegetable protein sources are cereals such as barley, wheat, rye, oat, maize (corn), rice, triticale, sorghum, dried distillers grains with solubles (DDGS) and microalgae.

The protein source may also be a non-protein nitrogen source which can be utilized by a ruminant to satisfy its protein requirements, e.g., urea or ammonia.

The protein source may be an essential amino acid, i.e., an amino acid that must be added to the animal's diet because it either cannot be synthesized or cannot be synthesized in large enough quantities to meet the daily requirement. Essential amino acids include but are not limited to phenylalanine, valine, threonine, methionine, arginine, tryptophan, histidine, isoleucine, leucine, and lysine.

The treatment according to the invention of proteins with at least one treated cellulosic material results in an increased digestibility of proteins. At least 101%, or 102%, 103%, 104%, 105%, 106%, 107%, 108%, 109%, 110%, 111%, 112%, 113%, 114%, 115%, or at least 116% digestible protein may be obtainable using the treated cellulosic material.

In a particular embodiment of a treatment process the treated cellulosic material affects (or acts on, or exerts its influence on) the proteins, such as vegetable proteins or protein sources. To achieve this, the protein or protein source is typically suspended in a solvent, e.g., an aqueous solvent such as water, and the pH and temperature values are adjusted paying due regard to the characteristics of the treated cellulosic material.

In one embodiment the treatment is a pretreatment of animal feed or proteins for use in animal feed, i.e., the proteins are solubilized before intake.

The term improving the nutritional value of an animal feed means improving the availability of the proteins, thereby leading to increased protein extraction, higher protein yields, and/or improved protein utilization. The nutritional value of the feed is therefore increased, and the growth rate and/or weight gain and/or feed conversion (i.e., the weight of ingested feed relative to weight gain) of the animal is/are improved.

In a further aspect the present invention relates to compositions for use in animal feed, such as animal feed, and animal feed additives, e.g., premixes.

The animal feed additives of the invention contain at least one fat-soluble vitamin, and/or at least one water soluble vitamin, and/or at least one trace mineral, and/or at least one macro mineral.

The animal feed composition may further comprise an organic acid. Organic acids suitable for use within specific non-limiting embodiments of the present disclosure include, but are not limited to, ascorbic acid, citric acid, aconitic acid, malic acid, fumaric acid, succinic acid, lactic acid, malonic acid, maleic acid, tartaric acid, aspartic acid, oxalic acid, tatronic acid, oxaloacetic acid, isomalic acid, pyrocitric acid, glutaric acid, ketoglutaric acid, and mixtures thereof. The organic acids may be added to the composition as the free-acid or as a salt. Suitable organic acid salts include, but are not limited to, sodium salts, potassium salts, magnesium salts, calcium salts, and ammonium salts. In one non-limiting embodiment, the organic acid or salt thereof, such as ascorbic acid, citric acid, aconitic acid, malic acid, fumaric acid, succinic acid, lactic acid, malonic acid, maleic acid, tartaric acid, aspartic acid, pyrocitric acid, or mixtures and salts thereof, may be added to the compositions in amounts from 0.1% to 6.0% by weight.

The animal feed composition may further comprise a gluten protein from a cereal grain, which is a storage protein classified in four types according to their solubility: albumins which are soluble in water or aqueous salt solutions, globulins which are insoluble in water but soluble in dilute salt solutions, prolamins which are soluble in alcohol, and glutelins which are soluble in dilute acid or base. Suitable gluten proteins include, but are not limited to, wheat gluten proteins, corn gluten proteins, oat gluten proteins, rye gluten proteins, rice globulin proteins, barley gluten proteins, and mixtures thereof. The gluten proteins of the compositions of the present disclosures may be added to the compositions in the form of the isolated gluten proteins, or as a gluten meal. In various embodiments of the present disclosure comprising a gluten protein, such as corn gluten protein, wheat gluten protein, or rice globulin proteins, the gluten protein may comprise from 0.25% to 50.0% by weight of the composition.

The animal feed compositions may further comprise a divalent metal ion, e.g., of zinc, manganese and iron. Non-limiting examples of metal ions suitable for use in various non-limiting embodiments of the compositions of the present disclosure are water soluble salts, for example, sulfate salts, of divalent zinc, divalent manganese and divalent iron, although it is important to note that all water soluble salts, and combinations of metals or metal salts, may be used in the practice of the present disclosure. The metal salts may be added to the compositions either as a single chemical entity or as a mixture of more than one salt composition, which may include salts containing the same metal ion and salts with differing metal ions.

The animal feed composition may further comprise a plant extract, e.g., for use as a flavoring agent. As used herein, the term “plant extract” is defined as a compound in any form, for example a liquid, an oil, a crystal, or a dry powder, isolated from a botanical source that can be incorporated into certain non-limiting embodiments of the compositions of the present disclosure. Plant extracts suitable for use in certain non-limiting embodiments of the present compositions include, but are not limited to, saponins from yucca plants, saponins from quillaja plants, saponins from soybeans, tannins, cinnamaldehyde, eugenol or other extracts of clove buds, including clove oil or clove powder, garlic extracts, cassia extracts, capsaicin, anethol or mixtures thereof.

The animal feed composition may further comprise at least one proteinaceous feed ingredient, such as, plant and vegetable proteins, including edible grains and grain meals selected from the group consisting of soybeans, soybean meal, corn, corn meal, linseed, linseed meal, cottonseed, cottonseed meal, rapeseed, rapeseed meal, sorghum protein, and canola meal. Other examples of proteinaceous feed ingredients may include; corn or a component of corn, such as, for example, corn fiber, corn hulls, silage, ground corn, or any other portion of a corn plant; soy or a component of soy, such as, for example, soy hulls, soy silage, ground soy, or any other portion of a soy plant; wheat or any component of wheat, such as, for example, wheat fiber, wheat hulls, wheat chaff, ground wheat, wheat germ, or any other portion of a wheat plant; canola or any other portion of a canola plant, such as, for example, canola protein, canola hulls, ground canola, or any other portion of a canola plant; sunflower or a component of a sunflower plant; sorghum or a component of a sorghum plant; sugar beet or a component of a sugar beet plant; cane sugar or a component of a sugarcane plant; barley or a component of a barley plant; corn steep liquor; a waste stream from an agricultural processing facility; soy molasses; flax; peanuts; peas; oats; grasses, such as orchard grass and fescue, and alfalfa, clover used for silage or hay.

The animal feed composition may further comprise an essential amino acid. Essential amino acids include but are not limited to phenylalanine, valine, threonine, methionine, arginine, tryptophan, histidine, isoleucine, leucine, and lysine.

In a particular embodiment, the animal feed composition comprises distillers dried grains (DDG) and distillers dried grains with soluble (DDGS).

Further, optional, feed-additive ingredients are coloring agents, e.g., carotenoids such as beta-carotene, astaxanthin, and lutein; stabilizers; growth improving additives and aroma compounds/flavorings, e.g., creosol, anethol, deca-, unceca- and/or dodca-lactones, ionones, irone, gingerol, piperidine, propylidene phatalide, butylidene phatalide, capsaicin and/or tannin; antimicrobial peptides; polyunsaturated fatty acids (PUFAs); reactive oxygen generating species; also, a support may be used that may contain, for example, 40-50% by weight of wood fibers, 8-10% by weight of stearine, 4-5% by weight of curcuma powder. 4-58% by weight of rosemary powder, 22-28% by weight of limestone, 1-3% by weight of a gum, such as gum Arabic, 5-50% by weight of sugar and/or starch and 5-15% by weight of water.

A feed or feed additive may also comprise at least one other enzyme selected from the group consisting of phytase (EC 3.1.3.8 or 3.1.3.26); xylanase (EC 3.2.1.8); galactanase (EC 3.2.1.89); alpha-galactosidase (EC 3.2.1.22); protease (EC 3.4.-.-), phospholipase A1 (EC 3.1.1.32); phospholipase A2 (EC 3.1.1.4); lysophospholipase (EC 3.1.1.5); phospholipase C (3.1.4.3); phospholipase D (EC 3.1.4.4); amylase such as, for example, alpha-amylase (EC 3.2.1.1); and/or beta-glucanase (EC 3.2.1.4 or EC 3.2.1.6).

Examples of antimicrobial peptides (AMP's) are CAP18, Leucocin A, Tritrpticin, Protegrin-1, Thanatin, Defensin, Lactoferrin, Lactoferricin, and Ovispirin such as Novispirin (Robert Lehrer, 2000), Plectasins, and Statins, including the compounds and polypeptides disclosed in WO 03/044049 and WO 03/048148, as well as variants or fragments of the above that retain antimicrobial activity.

Examples of antifungal polypeptides (AFP's) are the Aspergillus giganteus and Aspergillus niger peptides, as well as variants and fragments thereof which retain antifungal activity, as disclosed in WO 94/01459 and WO 02/090384.

Examples of polyunsaturated fatty acids are C18, C20 and C22 polyunsaturated fatty acids, such as arachidonic acid, docosohexaenoic acid, eicosapentaenoic acid and gamma-linoleic acid.

Examples of reactive oxygen generating species are chemicals such as perborate, persulphate, or percarbonate; and enzymes such as an oxidase, an oxygenase or a syntethase.

Usually fat- and water-soluble vitamins, as well as trace minerals form part of a so-called premix intended for addition to the feed, whereas macro minerals are usually separately added to the feed. Either of these composition types is an animal feed additive of the invention.

In a particular embodiment, the animal feed additive is included (or prescribed as having to be included) in animal diets or feed at levels of 0.01 to 10.0%; more particularly 0.05 to 5.0%; or 0.2 to 1.0% (% meaning g additive per 100 g feed). This is so in particular for premixes.

The following are non-exclusive lists of examples of these components:

Examples of fat-soluble vitamins are vitamin A, vitamin D3, vitamin E, and vitamin K, e.g., vitamin K3.

Examples of water-soluble vitamins are vitamin B12, biotin and choline, vitamin B1, vitamin B2, vitamin B6, niacin, folic acid and panthothenate, e.g., Ca-D-panthothenate.

Examples of trace minerals are manganese, zinc, iron, copper, iodine, selenium, and cobalt.

Examples of macro minerals are calcium, phosphorus and sodium.

The nutritional requirements of these components (exemplified with poultry and piglets/pigs) are listed in Table A of WO 01/58275. Nutritional requirement means that these components should be provided in the diet in the concentrations indicated.

In the alternative, the animal feed additive of the invention comprises at least one of the individual components specified in Table A of WO 01/58275. At least one means either of, one or more of, one, or two, or three, or four and so forth up to all thirteen, or up to all fifteen individual components. More specifically, this at least one individual component is included in the additive of the invention in such an amount as to provide an in-feed-concentration within the range indicated in column four, or column five, or column six of Table A.

In a still further embodiment, the animal feed additive of the invention comprises at least one of the below vitamins, e.g., to provide an in-feed-concentration within the ranges specified in the following table (for piglet diets, and broiler diets, respectively).

Typical vitamin recommendations

| Vitamin | Piglet diet | | Broiler diet | |
|---|---|---|---|---|
| Vitamin A | 10,000-15,000 | IU/kg feed | 8-12,500 | IU/kg feed |
| Vitamin D3 | 1800-2000 | IU/kg feed | 3000-5000 | IU/kg feed |
| Vitamin E | 60-100 | mg/kg feed | 150-240 | mg/kg feed |
| Vitamin K3 | 2-4 | mg/kg feed | 2-4 | mg/kg feed |
| Vitamin B1 | 2-4 | mg/kg feed | 2-3 | mg/kg feed |
| Vitamin B2 | 6-10 | mg/kg feed | 7-9 | mg/kg feed |
| Vitamin B6 | 4-8 | mg/kg feed | 3-6 | mg/kg feed |
| Vitamin B12 | 0.03-0.05 | mg/kg feed | 0.015-0.04 | mg/kg feed |
| Niacin | 30-50 | mg/kg feed | 50-80 | mg/kg feed |
| (Vitamin B3) | | | | |
| Pantothenic | 20-40 | mg/kg feed | 10-18 | mg/kg feed |
| acid | | | | |
| Folic acid | 1-2 | mg/kg feed | 1-2 | mg/kg feed |
| Biotin | 0.15-0.4 | mg/kg feed | 0.15-0.3 | mg/kg feed |
| Choline | 200-400 | mg/kg feed | 300-600 | mg/kg feed |
| chloride | | | | |

The present invention also relates to animal feed compositions. Animal feed compositions or diets have a relatively high content of protein. Poultry and pig diets can be characterized as indicated in Table B of WO 01/58275, columns 2-3. Fish diets can be characterized as indicated in column 4 of this Table B. Furthermore such fish diets usually have a crude fat content of 200-310 g/kg. WO 01/58275 corresponds to U.S. application no. 09/779,334 which is hereby incorporated by reference.

An animal feed composition according to the invention has a crude protein content of 50-800 g/kg, and furthermore comprises at least one protease as claimed herein.

Furthermore, or in the alternative (to the crude protein content indicated above), the animal feed composition of the invention has a content of metabolisable energy of 10-30 MJ/kg; and/or a content of calcium of 0.1-200 g/kg; and/or a content of available phosphorus of 0.1-200 g/kg; and/or a content of methionine of 0.1-100 g/kg; and/or a content of methionine plus cysteine of 0.1-150 g/kg; and/or a content of lysine of 0.5-50 g/kg.

In particular embodiments, the content of metabolisable energy, crude protein, calcium, phosphorus, methionine, methionine plus cysteine, and/or lysine is within any one of ranges 2, 3, 4 or 5 in Table B of WO 01/58275 (R. 2-5).

Crude protein is calculated as nitrogen (N) multiplied by a factor 6.25, i.e., Crude protein (g/kg)=N (g/kg)×6.25. The nitrogen content is determined by the Kjeldahl method (A.O.A.C., 1984, Official Methods of Analysis 14th ed., Association of Official Analytical Chemists, Washington D.C.).

Metabolisable energy can be calculated on the basis of the NRC publication Nutrient requirements in swine, ninth revised edition 1988, subcommittee on swine nutrition, committee on animal nutrition, board of agriculture, national research council. National Academy Press, Washington, D.C., pp. 2-6, and the European Table of Energy Values for Poultry Feed-stuffs, Spelderholt centre for poultry research and extension, 7361 DA Beekbergen, The Netherlands. Grafisch bedrijf Ponsen & looijen by, Wageningen. ISBN 90-71463-12-5.

The dietary content of calcium, available phosphorus and amino acids in complete animal diets is calculated on the basis of feed tables such as Veevoedertabel 1997, gegevens over chemische samenstelling, verteerbaarheid en voederwaarde van voedermiddelen, Central Veevoederbureau, Runderweg 6, 8219 pk Lelystad. ISBN 90-72839-13-7.

In a particular embodiment, the animal feed composition contains at least one vegetable protein as defined above. The animal feed composition may also contain animal protein, such as Meat and Bone Meal, and/or Fish Meal, typically in an amount of 0-25%. The animal feed composition may also comprise Dried Distillers Grains with Solubles (DDGS), typically in amounts of 0-30%.

In still further particular embodiments, the animal feed composition contains 0-80% maize; and/or 0-80% sorghum; and/or 0-70% wheat; and/or 0-70% barley; and/or 0-30% oats; and/or 0-40% soybean meal; and/or 0-25% fish meal; and/or 0-25% meat and bone meal; and/or 0-20% whey.

Animal diets can, e.g., be manufactured as mash feed (non pelleted) or pelleted feed. Typically, the milled feed-stuffs are mixed and sufficient amounts of essential vitamins and minerals are added according to the specifications for the species in question. Enzymes can be added as solid or liquid enzyme formulations. For example, for mash feed a solid or liquid enzyme formulation is typically added before or during the ingredient mixing step. For pelleted feed the (liquid or sold) enzyme preparation may be added before or during the feed ingredient step. Typically a liquid enzyme preparation is added after the pelleting step. The enzyme may also be incorporated in a feed additive or premix.

The final enzyme concentration in the diet is within the range of 0.01-200 mg enzyme protein per kg diet, for example in the range of 0.5-25 mg enzyme protein per kg animal diet.

The treated cellulosic material should be applied in an effective amount, i.e., in an amount adequate for improving digestibility.

### In Vitro True Digestibility (IVTD)

IVTD is an anaerobic fermentation performed in the laboratory to simulate digestion as it occurs in the rumen. Rumen fluid is collected from ruminally cannulated high producing dairy cows consuming a typical total mixed ration (TMR). Forage samples are incubated in rumen fluid and buffer for a specified time period at 39° C. (body temperature). During this time, the microbial population in the rumen fluid digests the sample as would occur in the rumen. Upon completion, the samples are extracted in neutral detergent solution to leave behind the undigested fibrous residue. The result is a measure of digestibility that can be used to estimate the digestibility of cellulosic materials; e.g., corn stover, corn fiber, soybean stover, soybean fiber, rice straw, pine wood, wood chips, poplar, wheat straw, switchgrass, bagasse, etc. In general, the higher the value of IVTD, the higher is the digestibility of the forage and the higher is the feed value of the forages for feeding ruminants.

The first stage of the In Vitro True Digestibility (IVTD) is a 24, 30 or 48 hour incubation in rumen fluid and buffer. The second stage substitutes a neutral detergent fiber (NDF) extraction for the pepsin and HCl. NDF is a measurement of hemicellulose, cellulose, and lignin representing the fibrous bulk of cellulosic material(s). These three components are classified as cell wall or structural carbohydrates. They give the plant rigidity enabling it to support itself as it grows, much like the skeleton in animals. Hemicellulose and cellulose can be broken down by microbes in the rumen to provide energy to the animal. NDF is negatively correlated with intake. The NDF extraction more completely removes bacterial residues and other pepsin insoluble material yielding a residue free of microbial contamination. Additionally, it shortens the analysis time by two days.

### EXAMPLES

### Example 1

### Microbial Treatment of Cellulosic Material

### Extrusion

Corn stover was ground through a 25.4 mm screen and prewetted with water to produce a suspension. Calcium oxide (CaO) was mixed into the suspension and applied alone or in combination with NaOH by means of an injection port into a Readco® Continuous Processor (Readco Kurimoto, LLC, York, Pa., USA). The processor was set for all treatments to have approximately 15 seconds retention time for chemical treatment addition, agitation, and particle size reduction. Estimated throughput of the processor during testing was 200 kg of dry weight per hour. All of the chemical additions except for CaO were performed with no added heat. However, heat was generated by the chemical reactions, which are exothermic. The exit temperature of the treated material was approximately 60° C. to 80° C. A pressure plate was not used in these trials and so the treated particles were not agglomerated after treatment. The treated material was conveyed to barrels or supersacks for subsequent storage before being fed.

The treatments to increase the digestibility of corn stover are described in Table 1 (see also, U.S. Pat. Nos. 7,494,675 and 7,998,511 concerning the treatment of lignocellulosics for improving animal feed). One of the advantages of a mechanical twin screw extruder is that the amount of chemicals added may be less as the processor distributes the chemicals more effectively than conventional mixing equipment.

TABLE 1
Readco Processing of Corn Stover

| Treatment | Amount added as % of Dry Matter | Total Moisture, % |
|---|---|---|
| CaO | 5.0 | 35 |
| CaO | 5.0 | 50 |
| CaO | 10.0 | 35 |
| CaO + NaOH | 4.0 and 1.0 | 50 |
| CaO + NaOH | 3.0 and 2.0 | 50 |

### Batch Processing

Corn stover was ground through a 25.4 mm screen and the moisture content of the ground material was measured. The ground stover was then loaded into a feed mixer wagon fitted with a horizontal reel auger. Based on the initial moisture content, additional water was added to achieve approximately 35% or 50% moisture and pulverized reactive CaO (lime) or NaOH was added at 5% of dry matter weight. Each of the treated materials was mixed >5 to <10 minutes and then discharged to a conveyor which loaded a bagging device. The treated materials were compressed into separate bags and kept anaerobic until feeding.

### Silage Simulation of Alkaline Pretreated Corn Stover

A total of 100 g dry weight of each of the lime pretreated corn stovers described above (extruded (5% CaO and 35% moisture, initial pH about 8.2) or batch processed (5% CaO and 50% moisture, initial pH about 8.7 or 5% NaOH and 50% moisture, initial pH about 11.5)) was inoculated separately with eleven different Bacillus strains at a rate of approximately 5×10⁷ cfu/g total solids of pretreated corn stover in 1 gallon vacuum bags. The Bacillus strains were:

Bacillus pumilus ATTC 700385

Bacillus lichenformis NRRL B-50015

Bacillus subtilis NRRL B-50136

Bacillus subtilis NRRL B-50605

Bacillus subtilis NRRL B-50606

Bacillus amyloliquefaciens NRRL B-50607

Bacillus licheniformis NRRL B-50621

Bacillus subtilis NRRL B-50622

Bacillus licheniformis NRRL B-50623

Bacillus amyloliquefaciens PTA-7543

Bacillus subtilis PTA-7547

The microbes were thoroughly mixed with the corn stover. A vacuum was applied and the bags were sealed using a commercially available vacuum system creating an anaerobic environment. The bags were incubated at 37° C. for up to 3 weeks.

### In Vitro True Digestibility—Dairy One Forage Laboratory

Following the silage simulation, in vitro true digestibility (IVTD) studies were conducted by Dairy One Forage Laboratory (Ithaca, N.Y., USA). The silaged corn stover was removed from each bag (see above), dried for 4 hours at 60° C., and then ground through a 1 mm UDY Cyclone Mill (UDY Corp., Fort Collins, Colo., USA). Totally 250 mg of dried, milled-corn stover were incubated in Van Soest buffer (Goering and Van Soest, 1970, Forage fiber analysis (apparatus, reagents, procedures and some applications), Agricultural Handbook No. 379 ARS-USDA, Washington, D.C.) with rumen fluid from high producing dairy cows consuming a typical Total Mixed Rations (TMR) diet. The incubations were performed at 39° C. for 48 hours in ANOKM® F57 filter bags (ANOKM Technology, Macedon, N.Y., USA). After incubation, samples of the undigested fibrous residue were determined using an NDF procedure (ANKOM A200 Filter Bag Technique (FBT), ANKOM Application Note 01/02 “Method for Determining Neutral Detergent Fiber (aNDF)”. Solutions are described in Journal of Dairy Science 74: 3583-3597 (1991)). The digestibility was determined by the undigested fibrous residue remaining after digestion. An increase in digestibility was determined by comparison of the average % of digested material for the untreated control compared to the average percent of digested material for the microbial treatment samples.

Three separate silage samples for each microbial inoculant were assessed to provide the standard deviation shown in Tables 2-7.

TABLE 2
Results of in vitro true digestibility analysis of CaO batch
treated corn stover at 37° C. for a period of one week

| | IVTD: % of DM | STDEV |
|---|---|---|
| ATTC 700385 | 72.0 | 1.7 |
| NRRL B-50015 | 69.7 | 2.1 |
| NRRL B-50136 | 73.3 | 2.9 |
| NRRL B-50605 | 71.3 | 1.2 |
| NRRL B-50606 | 72.3 | 0.6 |
| NRRL B-50607 | 69.0 | 3.6 |
| NRRL B-50621 | 71.3 | 2.5 |
| NRRL B-50622 | 70.7 | 0.6 |
| NRRL B-50623 | 72.7 | 1.2 |
| PTA-7543 | 71.0 | 2.0 |
| PTA-7547 | 68.0 | 2.6 |
| Untreated Control | 69.7 | 4.5 |

TABLE 3
Results of in vitro true digestibility analysis of CaO batch
treated corn stover at 37° C. for a period of one week

| | Trial 1 | Trial 2 | | |
|---|---|---|---|---|
| | IVTD: | IVTD: | | |
| | % of DM | % of DM | STDEV | STDEV |
| ATTC 700385 | 71.3 | 72.0 | 3.8 | 1.7 |
| NRRL B-50136 | 76.7 | 73.3 | 2.5 | 2.9 |
| NRRL B-50606 | 74.3 | 72.3 | 3.5 | 0.6 |
| NRRL B-50621 | 71.0 | 71.3 | 3.5 | 2.5 |
| NRRL B-50623 | 65.7 | 72.7 | 2.9 | 1.2 |
| Untreated Control | 67.0 | 69.7 | 6.2 | 4.5 |

TABLE 4
Results of in vitro true digestibility analysis of CaO batch
treated corn stover at 37° C. for a period of three weeks

| | IVTD: % of DM | STDEV |
|---|---|---|
| ATTC 700385 | 62.0 | 4.0 |
| NRRL B-50136 | 71.0 | 3.6 |
| NRRL B-50606 | 59.7 | 5.8 |
| NRRL B-50621 | 64.0 | 6.1 |
| NRRL B-50623 | 73.7 | 2.5 |
| Untreated Control | 59.7 | 3.8 |

TABLE 5
Results of in vitro true digestibility analysis of CaO
extruded corn stover at 37° C. for a period of one week

| | IVTD: % of DM | STDEV |
|---|---|---|
| ATTC 700385 | 73.3 | 1.5 |
| NRRL B-50136 | 69.3 | 4.0 |
| NRRL B-50606 | 74.0 | 1.7 |
| NRRL B-50621 | 69.7 | 1.2 |
| NRRL B-50623 | 70.7 | 0.6 |
| Untreated Control | 67.7 | 4.0 |

TABLE 6
Results of in vitro true digestibility analysis of untreated
corn stover at 37° C. for a period of one week

| | IVTD: % of DM | STDEV |
|---|---|---|
| ATTC 700385 | 56.3 | 1.5 |
| NRRL B-50136 | 55.7 | 1.5 |
| NRRL B-50606 | 57.3 | 1.2 |
| NRRL B-50621 | 55.0 | 1.0 |
| NRRL B-50623 | 56.7 | 3.1 |
| Untreated Control | 57.0 | 2.0 |

TABLE 7
Results of in vitro true digestibility analysis of NaOH batch
treated corn stover at 37° C. for a period of one week

| | IVTD: % of DM | STDEV |
|---|---|---|
| ATTC 700385 | 93.7 | 2.3 |
| NRRL B-50136 | 92.7 | 0.6 |
| NRRL B-50606 | 92.7 | 1.5 |
| NRRL B-50621 | 92.0 | 1.0 |
| NRRL B-50623 | 91.7 | 2.5 |
| Untreated Control | 95.3 | 0.6 |

The addition of each Bacillus strain increased the IVTD of the calcium oxide treated corn stover compared to the untreated control and was reproducible (Table 3). Continued increase in digestibility occurred with increased silage time, +11% of dry matter with Bacillus subtilis NRRL B-50136 and +14% of dry matter with Bacillus licheniformis NRRL B-50623 compared to the untreated control (Table 4).

A similar increase in digestibility was shown for calcium oxide extruded stover treated with each Bacillus strain (Table 5). The tested microbial inoculants did not increase the digestibility of untreated corn stover or 5% NaOH pretreated corn stover assessed under the conditions described above (Tables 6 and 7). Possible reasons include competition with native strains and severity of alkaline treatment, especially higher initial pH of 11.5.

### Example 2

### Materials

ULTRAFLO L-Humicola insolens composition comprising acetylxylan esterase, alpha-L-arabinofuranosidase, beta-glucosidase, beta-xylosidase, cellobiohydrolase, cellobiose dehydrogenase, endogalactosidase, endoglucanase, ferulic acid esterase, and xylanase.
Cellulolytic Enzyme Composition 1: A blend of an Aspergillus aculeatus GH10 xylanase (WO 94/21785) and a Trichoderma reesei cellulase preparation containing Aspergillus fumigatus beta-glucosidase (WO 2005/047499) and Thermoascus aurantiacus GH61A polypeptide (WO 2005/074656).
Cellulolytic Enzyme Composition 2: A blend of an Aspergillus fumigatus GH10 xylanase (WO 2006/078256) and Aspergillus fumigatus beta-xylosidase (WO 2011/057140) with a Trichoderma reesei cellulase preparation containing Aspergillus fumigatus cellobiohydrolase I (WO 2011/057140), Aspergillus fumigatus cellobiohydrolase II (WO 2011/057140), Aspergillus fumigatus beta-glucosidase variant (WO 2012/044915), and Penicillium sp. (emersonii) GH61 polypeptide (WO 2011/041397).

### Enzyme and Microbial Treatment of Cellulosic Material

Alkaline pretreated corn stover (5% CaO, 35% moisture) from the extrusion process described in Example 1 under “Extrusion” was obtained from ADM (Decatur, Ill., USA). The pH of the treated material was about 9. No additional washing step or pH adjustment step to reduce the pH was performed. The total solids content was measured using a Mettler-Toledo halogen moisture balance (Model #H663). Totally 100 g of dry equivalent pretreated corn stover were dosed with water, enzymes and microbe to reach a total stover solid content of 50% under the following combinations:
i) water alone (Control)
ii) ULTRAFLO® L at 0.15 wt. % of dry matter (0.15 g of product per 100 g of dry stover) and water
iii) Bacillus licheniformis (NRRL B-50621) at a dose level of 1×10⁷ CFU/g dry stover and water
iv) ULTRAFLO® L at 0.15 wt. % of dry matter and Bacillus licheniformis (NRRL B-50621) at a dose level of 1×10⁷ CFU/g dry stover and water
v) ULTRAFLO® L at 0.15 wt. % of dry matter and Cellulolytic Enzyme Composition 2 at 0.2 wt. % of dry matter (0.2 g of product per 100 g of dry stover) and water

The resulting materials were mixed by hand for five minutes. Each mixture was allowed to sit for ten minutes before the samples were separated into four bags of approximately 50 g each. A vacuum was applied and the bags were sealed using a commercially available vacuum system creating an anaerobic environment. The bags were incubated at 37° C. for three weeks. After three weeks of incubation, quadruplicate 50 gram samples were sent to Dairy One Forage Laboratory for in vitro true digestibility (IVTD) testing.

The avg. IVTD data from Dairy One Forage Laboratory, average improvement in IVTD (as % of dry matter (DM) over the control), and the standard deviation (of quadruplicate samples) obtained for various treatments as described above are provided in Table 8.

TABLE 8
Results from 3 week incubation at 37° C.

| | | | Avg IVTD |
|---|---|---|---|
| | IVTD | | Improvement |
| Description | (% of DM) | Stdev | (% of DM) |
| No Enzyme, No microbe (Control) | 66.8 | 2.6 | 0 |
| ULTRAFLO ® L | 68.0 | 1.0 | 1.2 |
| Bacillus lichenformis | 70.3 | 3.1 | 3.5 |
| ULTRAFLO ® L + | 71.8 | 3.9 | 5.0 |
| Bacillus lichenformis | | | |
| Cellulolytic Enzyme Composition | 73.5 | 3.1 | 6.7 |
| 2 + ULTRAFLO ® L | | | |

The data demonstrates that ULTRAFLO® L (Humicola insolens) and Bacillus licheniformis (NRRL B-50621) increased the rumen in vitro digestibility of alkaline stover even without pH adjustment. Further, by combining ULTRAFLO® L with Bacillus licheniformis (NRRL B-50621) or Cellulolytic Enzyme Composition 2, the rumen digestibility can be further enhanced which increases the feed value of alkaline treated stover for feeding ruminants.

### Example 3

Untreated raw corn stover ground to 6 mm or less was obtained from Iowa State University. The ground untreated stover had some larger pieces (2-3 inches long) and some pieces of cob and kernel which were removed (estimated to be about 10-15% by weight). The stover was sifted through a sieve to remove some of the dust. The total solids content was measured using a Mettler-Toledo halogen moisture balance. Approximately 2.5 kg of the above corn stover was combined with water using a Kitchen Aid mixer to reach a total solid content of 70%. Then, 800 g of this untreated stover was placed in a batch reactor (Lab-O-Mat, Werner Mathis USA Inc., Concord, N.C., USA) for 15 minutes at 140° C. After heat treatment, about 400 g of the heat treated stover was dosed with Cellulolytic Enzyme Composition 1 and water to reach a total solid content of 50%. Cellulolytic Enzyme Composition 1 was dosed at 0, 0.1 and 1% wt. % on solids (which is 0, 0.1 g and 1 g of product per 100 g of dry corn stover solids). A Kitchen Aid mixer (4.5 quarts, stand mixer) was used to mix the water and/or enzyme with the heat treated corn stover. About 250 g of the treated samples (at about 50% solids) in duplicate were then incubated at 30° C. for one week in a plastic bag. After one week of incubation the samples were sent to Dairy One Forage Laboratory for 48 hour in vitro true digestibility (IVTD) testing.

The average IVTD data from Dairy One Forage Laboratory, average improvement in IVTD (as % of dry matter (DM) over the untreated control), and the standard deviation (of duplicate samples) obtained for these treatments are provided in Table 9.

TABLE 9
Results after 1 week incubation at 30° C.

| | | | Avg IVTD |
|---|---|---|---|
| | IVTD | | Improvement |
| Description | (% of DM) | Stdev | (% of DM) |
| Untreated stover (Control) | 57.5 | 3.5 | 0 |
| Heat treated stover with no enzyme | 59.0 | 0.0 | 1.5 |
| Cellulolytic Enzyme Composition 1 | 67.0 | 1.4 | 9.5 |
| dosed at 0.1 wt. % on heat treated | | | |
| stover | | | |
| Cellulolytic Enzyme Composition 1 | 68.0 | 2.8 | 10.5 |
| dosed at 1 wt. % on heat treated | | | |
| stover | | | |

The data shows that heat treatment alone increased the rumen digestibility of corn stover, but adding Cellulolytic Enzyme Composition 1 further enhanced the rumen digestibility of heat treated stover substantially.

### Example 4

Corn stover (Mahomet farm, IL, 2011 harvest) was ground through a 1″ screen using a tub grinder (HayBuster H1000) and then hydrated to 45% moisture. Standard quicklime (5 wt. % of dry stover) was applied during mixing in a mixer wagon (Kuhn and Knight 3130) and the treated stover was aerobically stored for 8 days in a storage bay. After the initial curing step, lime treated stover was transferred from the storage bay to a mixer wagon (Kuhn and Knight 3130) for mixing the microbes and enzymes into the material using the following treatments:

a) Bacillus subtilis (NRRL B-50606) at a dose of 1×10⁷ CFU/gm stover (Treatment A)
b) Bacillus subtilis (NRRL B-50136) at a dose of 1×10⁷ CFU/gm stover (Treatment B)
c) Bacillus subtilis (NRRL B-50606) at a dose of 1×10⁷ CFU/gm stover along with enzyme ULTRAFLO®L at a dose of 0.15 wt. % (as wt. % of dry stover, which is 0.15 g of product per 100 g dry stover) (Treatment C)

The enzymes and microbes were first mixed with water to facilitate dispersion through the stover and the final moisture was brought to about 50 wt. %. About 1400 kg of treated stover from each of treatments A, B and C above (at 50% moisture) was returned to storage and anaerobically stored for 3 weeks before feeding. In addition, following feed ingredients were procured. Corn (from Urabana, Ill. farm), wet distillers grains and solubles (WDGS) from ADM plant Peoria, Ill. plant, vitamins/minerals supplement (Beef research unit at Univ of Illinois). Ingredients were mixed on a dry matter basis as identified below as Recipe A, B, and C in addition to standard industry feedlot diet. About 45% reduction in corn usage compared to standard feedlot diet was targeted using treated stover from treatments A, B, and C.

Angus cross heifers (average initial body weight=616±9 kg) were used in a 26 day feeding trial (Beef research unit, Univ of Illinois). Heifers were weighed on day 2 and randomly assigned to 1 of 4 pens. Each pen (4 animals/pen) was assigned to one of the following treatments: (% represents wt. % on dry matter basis).

1) standard industry feedlot diet (5% untreated corn stover, 40% WDGS, 45% corn, and 10% vitamin/mineral supplement),

2) Recipe A (30% Treatment A stover, 40% WDGS, 25% corn, and 5% vitamin/mineral supplement),

3) Recipe B (30% Treatment B stover, 40% WDGS, 25% corn, and 5% vitamin/mineral supplement), and

4) Recipe C (30% Treatment C stover, 40% WDGS, 25% corn, and 5% vitamin/mineral supplement).

During the trial, individual intakes were recorded on all heifers using the GrowSafe system (supplied by Airdrie, Canada). Heifers were weighed again at the end of the trial to determine final body weight.

### Results:

Heifer performance results are summarized in Table 10 below:

| | Standard | | | | | |
|---|---|---|---|---|---|---|
| | industry | Recipe | Recipe | Recipe | | |
| | diet | A | B | C | SE | P-value |
| Starting | 610 | 635 | 611 | 610 | 22 | 0.91 |
| body weight, | | | | | | |
| kg | | | | | | |
| Ending body | 649 | 649 | 636 | 633 | 22 | 0.98 |
| weight, kg | | | | | | |
| Average | 1.53 | 0.53 | 1.00 | 0.91 | 0.224 | 0.08 |
| daily gain, | | | | | | |
| kg | | | | | | |
| Dry matter | 12.86 | 11.82 | 11.82 | 12.32 | 0.74 | 0.70 |
| intake, kg/d | | | | | | |

The dry matter intake data shows that lime treated corn stover mixed with microbes or microbes along with enzymes is palatable even when corn amounts are reduced by 45% in the diet and thus could be used to replace expensive corn for feeding ruminants. Recipe B containing Bacillus subtilis (NRRL B-50136) strain showed the best performance in terms of average daily gain and dry matter intake. Also, it is observed by comparing Recipe A and Recipe C that Humicola insolens protein complex addition to Bacillus subtilis improves palatability (dry matter intake) and also average daily gain.

### Deposit of Biological Material

The following biological materials have been deposited under the terms of the Budapest Treaty at American Type Culture Collection (ATCC), 10801 University Blvd., Manassas, Va. 20108, USA, and the Microbial Genomics and Bioprocessing Research Unit (NRRL) National Center for Agricultural Utilization Research 1815 N. University Street, Peoria, Ill. 61604, USA and given the following accession numbers:

TABLE 3
Deposit of Biological Material

| Identification | Accession Number | Date of Deposit |
|---|---|---|
| Bacillus pumilus | ATCC 700385 | 28 Oct. 1997 |
| Bacillus lichenformis | NRRL B-50015 | 14 Mar. 2007 |
| Bacillus subtilis | NRRL B-50136 | 30 May 2010 |
| Bacillus subtilis | NRRL B-50605 | 30 Nov. 2011 |
| Bacillus subtilis | NRRL B-50606 | 30 Nov. 2011 |
| Bacillus amyloliquefaciens | NRRL B-50607 | 30 Nov. 2011 |
| Bacillus licheniformis | NRRL B-50621 | 14 Dec. 2011 |
| Bacillus subtilis | NRRL B-50622 | 14 Dec. 2011 |
| Bacillus licheniformis | NRRL B-50623 | 14 Dec. 2011 |
| Bacillus amyloliquefaciens | PTA-7543 | 20 Apr. 2006 |
| Bacillus subtilis | PTA-7547 | 20 Apr. 2006 |

The strains have been deposited under conditions that assure that access to the culture will be available during the pendency of this patent application to one determined by foreign patent laws to be entitled thereto. The deposits represent a substantially pure culture of the deposited strain. The deposits are available as required by foreign patent laws in countries wherein counterparts of the subject application or its progeny are filed. However, it should be understood that the availability of a deposit does not constitute a license to practice the subject invention in derogation of patent rights granted by governmental action.

The invention described and claimed herein is not to be limited in scope by the specific embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims. In the case of conflict, the present disclosure including definitions will control.

Various references are cited herein, the disclosures of which are incorporated by reference in their entireties.

The invention is further defined in the following paragraphs:

1. A method for producing an animal feed comprising:

(a) pretreating a cellulosic material to separate and/or release cellulose, hemicellulose and/or lignin;

(b) inoculating said pretreated cellulosic material with at least one Bacillus strain;

(c) incubating said inoculated material with the at least one Bacillus strain; and

(d) adding a protein source to produce an animal feed additive;

wherein step (d) occurs after step (a), (b) or (c) or simultaneously with step (b) or (c).
2. The method of paragraph 1, wherein step (d) occurs after step (a).
3. The method of paragraph 1, wherein step (d) occurs after step (b).
4. The method of paragraph 1, wherein step (d) occurs after step (c).
5. The method of paragraph 1, wherein step (d) occurs simultaneously with step (b).
6. The method of paragraph 1, wherein step (d) occurs simultaneously with step (c).
7. The method of any of paragraphs 1-6, wherein the at least one Bacillus strain is a strain of a species selected from the group consisting of Bacillus amyloliquefaciens; Bacillus atrophaeus; Bacillus azotoformans; Bacillus brevis; Bacillus cereus; Bacillus circulans; Bacillus clausii; Bacillus coagulans; Bacillus firmus; Bacillus flexus; Bacillus fusiformis; Bacillus globisporus; Bacillus glucanolyticus; Bacillus infermus; Bacillus laevolacticus; Bacillus licheniformis; Bacillus marinus; Bacillus megaterium; Bacillus mojavensis; Bacillus mycoides; Bacillus pallidus; Bacillus parabrevis; Bacillus pasteurii; Bacillus polymyxa; Bacillus popiliae; Bacillus pumilus; Bacillus sphaericus; Bacillus subtilis; Bacillus thermoamylovorans; Bacillus thuringiensis, and any combination thereof.
8. The method of paragraph 7, wherein the at least one Bacillus strain is a strain of a species selected from the group consisting of Bacillus amyloliquefaciens, Bacillus licheniformis, Bacillus pumilus, Bacillus subtilis, and any combination thereof.
9. The method of paragraph 8, wherein the at least one Bacillus strain is selected from the group consisting of ATCC 700385, NRRL B-50136, NRRL B-50622, NRRL B-50623, NRRL B-50605, NRRL B-50621, NRRL B-50015, NRRL B-50607, NRRL B-50606, PTA-7543, PTA-7547, and any combination thereof.
10. The method of any of paragraphs 1-9, wherein said at least one microorganism is capable of producing hydrolytic enzymes, cellulolytic enzymes, or a combination thereof.
11. The method of any of paragraphs 1-10, wherein the cellulosic material is selected from the group consisting of corn stover, corn fiber, soybean stover, soybean fiber, rice straw, pine wood, wood chips, poplar, wheat straw, switchgrass, bagasse, green chopped whole corn, hay, alfalfa, and any combination thereof.
12. The method of paragraph 11, wherein said material is corn stover.
13. The method of any of paragraphs 1-12, wherein the pretreatment comprises chemical pretreatment.
14. The method of paragraph 13, wherein the chemical pretreatment is an alkaline chemical pretreatment.
15. The method of paragraph 14, wherein the alkaline chemical pretreatment is a treatment of calcium oxide, sodium hydroxide, ammonia, or a combination thereof.
16. The method of any of paragraphs 1-15, wherein the pretreatment comprises mechanical pretreatment.
17. The method of paragraph 16, wherein the mechanical pretreatment occurs contemporaneously with the chemical pretreatment.
18. The method of any of paragraphs 1-17, wherein the pretreatment comprises biological pretreatment.
19. The method of any of paragraphs 1-18, wherein the pretreatment comprises heat pretreatment.
20. The method of any of paragraphs 1-19, wherein the cellulosic material is incubated with the at least one Bacillus strain under aerobic conditions.
21. The method of any of paragraphs 1-19, wherein the cellulosic material is incubated with the at least one Bacillus strain under substantially anaerobic conditions.
22. The method of any of paragraphs 1-19, wherein the cellulosic material is incubated with the at least one Bacillus strain under anaerobic conditions.
23. The method of any of paragraphs 1-22, wherein the protein source is an animal protein or a vegetable protein.
24. The method of paragraph 23, wherein the animal protein is selected from the group consisting of meat meal, bone meal and fish meal.
25. The method of paragraph 23, wherein the vegetable protein is a legume or cereal.
26. The method of paragraph 23, wherein the vegetable protein is selected from the group consisting of barley, cabbage, cotton seed, lupin, maize, microalgae, oat, rapeseed, rice, rye, soy bean, sunflower seed, sorghum, triticale, and wheat.
27. The method of paragraph 23, wherein the protein source is dried distillers grains with solubles.
28. The method of paragraph 23, wherein the protein source is a non-protein nitrogen source which can be utilized by a ruminant to satisfy its protein requirements, e.g., urea or ammonia.
29. The method of paragraph 23, wherein the protein source is an essential amino acid, e.g., an amino acid selected from the group consisting of phenylalanine, valine, threonine, methionine, arginine, tryptophan, histidine, isoleucine, leucine, and lysine.
30. The method of any of paragraphs 1-29, which further comprises applying at least one additional microorganism to said cellulosic material.
31. The method of paragraph 30, wherein said at least one additional microorganism is a strain of Lactobacillus spp.
32. The method of paragraph 31, wherein said at least one additional microorganism is a strain of a species selected from the group consisting of Lactobacillus acetotolerans; Lactobacillus acidifarinaei, Lactobacillus acidipiscis; Lactobacillus acidophilus; Lactobacillus agilis; Lactobacillus algidus; Lactobacillus alimentarius; Lactobacillus amylolyticus; Lactobacillus amylophilus; Lactobacillus amylotrophicus; Lactobacillus amylovorus; Lactobacillus animalis; Lactobacillus antri; Lactobacillus apodemi; Lactobacillus aviaries; Lactobacillus bifermentans; Lactobacillus brevis; Lactobacillus buchneri; Lactobacillus cameffiae; Lactobacillus casei; Lactobacillus catenaformis; Lactobacillus ceti; Lactobacillus coleohominis; Lactobacillus coffinoides; Lactobacillus composti; Lactobacillus concavus; Lactobacillus coryniformis; Lactobacillus crispatus; Lactobacillus crustorum; Lactobacillus curvatus; Lactobacillus delbrueckii subsp. delbrueckii; Lactobacillus delbrueckii subsp. bulgaricus; Lactobacillus delbrueckii subsp. lactis; Lactobacillus dextrinicus; Lactobacillus diolivorans; Lactobacillus equi; Lactobacillus equigenerosi; Lactobacillus farraginis; Lactobacillus farciminis; Lactobacillus fermentum; Lactobacillus fomicalis; Lactobacillus fructivorans; Lactobacillus frumenti; Lactobacillus fuchuensis; Lactobacillus gaffinarum; Lactobacillus gasseri; Lactobacillus gastricus; Lactobacillus ghanensis; Lactobacillus graminis; Lactobacillus hammesii; Lactobacillus hamster, Lactobacillus harbinensis; Lactobacillus hayakitensis; Lactobacillus helveticus; Lactobacillus hilgardii; Lactobacillus homohiochii; Lactobacillus iners; Lactobacillus ingluviei; Lactobacillus intestinalis; Lactobacillus jensenii; Lactobacillus johnsonii; Lactobacillus kalixensis; Lactobacillus kefiranofaciens; Lactobacillus kefiri; Lactobacillus kimchii; Lactobacillus kitasatonis; Lactobacillus kunkeei; Lactobacillus leichmannii; Lactobacillus lindneri; Lactobacillus malefermentans; Lactobacillus mall; Lactobacillus manihotivorans; Lactobacillus mindensis; Lactobacillus mucosae; Lactobacillus murinus; Lactobacillus nagelii; Lactobacillus namurensis; Lactobacillus nantensis; Lactobacillus oligofermentans; Lactobacillus oris; Lactobacillus panis; Lactobacillus pantheris; Lactobacillus parabrevis; Lactobacillus parabuchneri; Lactobacillus paracollinoides; Lactobacillus parafarraginis; Lactobacillus parakefiri; Lactobacillus paralimentarius; Lactobacillus paraplantarum; Lactobacillus pentosus; Lactobacillus perolens; Lactobacillus plantarum; Lactobacillus pontis; Lactobacillus psittaci; Lactobacillus rennin; Lactobacillus reuteri; Lactobacillus rhamnosus; Lactobacillus rimae; Lactobacillus rogosae; Lactobacillus rossiae; Lactobacillus ruminis; Lactobacillus saerimneri; Lactobacillus sakei; Lactobacillus salivarius; Lactobacillus sanfranciscensis; Lactobacillus satsumensis; Lactobacillus secaliphilus; Lactobacillus sharpeae; Lactobacillus siliginis; Lactobacillus spicheri; Lactobacillus suebicus; Lactobacillus thailandensis; Lactobacillus ultunensis; Lactobacillus vaccinostercus; Lactobacillus vaginalis; Lactobacillus versmoldensis; Lactobacillus vini; Lactobacillus vitulinus; Lactobacillus zeae; Lactobacillus zymae.
33. The method of any of paragraphs 1-32, which further comprises applying at least one enzyme to the pretreated cellulosic material.
34. The method of paragraph 33, wherein the at least one enzyme is selected from the group consisting of amylases, carbohydrases, cellulases, esterases, expansions, GH61 polypeptides having cellulolytic enhancing activity, glucuronidases, hemicellulases, laccases, lipases, ligninolytic enzymes, pectinases, peroxidases, phytases, proteases, swollenins, xylanases, and any combination thereof.
35. A method for producing an animal feed comprising:

(a) pretreating a cellulosic material to separate and/or release cellulose, hemicellulose and/or lignin;

(b) inoculating said pretreated cellulosic material with at least one microorganism;

(c) incubating said inoculated material with the at least one microorganism;

(d) applying at least one enzyme to the pretreated cellulosic material; and

(e) adding a protein source to produce an animal feed additive;

wherein step (d) occurs after step (a), (b), (c) or (e) or simultaneously with step (b), (c) or (e) and step (e) occurs after step (a), (b), (c) or (d) or simultaneously with step (b), (c) or (d).
36. The method of paragraph 35, wherein step (d) occurs after step (a).
37. The method of paragraph 35, wherein step (d) occurs after step (b).
38. The method of paragraph 35, wherein step (d) occurs after step (c).
39. The method of paragraph 35, wherein step (d) occurs after step (e).
40. The method of paragraph 35, wherein step (d) occurs simultaneously with step (b).
41. The method of paragraph 35, wherein step (d) occurs simultaneously with step (c).
42. The method of paragraph 35, wherein step (d) occurs simultaneously with step (e).
43. The method of any of paragraphs 35-42, wherein step (e) occurs after step (a).
44. The method of any of paragraphs 35-42, wherein step (e) occurs after step (b).
45. The method of any of paragraphs 35-42, wherein step (e) occurs after step (c).
46. The method of any of paragraphs 35-42, wherein step (e) occurs after step (d).
47. The method of any of paragraphs 35-42, wherein step (e) occurs simultaneously with step (b).
48. The method of any of paragraphs 35-42, wherein step (e) occurs simultaneously with step (c).
49. The method of any of paragraphs 35-42, wherein step (e) occurs simultaneously with step (d).
50. The method of any of paragraphs 35-49, wherein the at least one microorganism comprises a Bacillus strain.
51. The method of paragraph 50, wherein the Bacillus strain is a strain of a species selected from the group consisting of Bacillus amyloliquefaciens, Bacillus atrophaeus, Bacillus azotoforman, Bacillus brevis, Bacillus cereus, Bacillus circulans, Bacillus clausii, Bacillus coagulans, Bacillus firmus, Bacillus flexus, Bacillus fusiformis, Bacillus globisporus, Bacillus glucanolyticus, Bacillus infermus, Bacillus laevolacticus, Bacillus licheniformis, Bacillus marinus, Bacillus megaterium, Bacillus mojavensis, Bacillus mycoides, Bacillus pallidus, Bacillus parabrevis, Bacillus pasteurii, Bacillus polymyxa, Bacillus popiliae, Bacillus pumilus, Bacillus sphaericus, Bacillus subtilis, Bacillus thermoamylovorans, Bacillus thuringiensis, and any combination thereof.
52. The method of paragraph 51, wherein the at least one bacteria is a strain of Bacillus selected from the group consisting of ATCC 700385, NRRL B-50136, NRRL B-50622, NRRL B-50623, NRRL B-50605, NRRL B-50621, NRRL B-50015, NRRL B-50607, NRRL B-50606, PTA-7543, PTA-7547, and any combination thereof.
53. The method of any of paragraphs 35-52, wherein the at least one microorganism comprises a Lactobacillus strain.
54. The method of paragraph 53, wherein the Lactobacillus strain is a strain of a species selected from the group consisting of Lactobacillus acetotolerans; Lactobacillus acidifarinaei, Lactobacillus acidipiscis; Lactobacillus acidophilus; Lactobacillus agilis; Lactobacillus algidus; Lactobacillus alimentarius; Lactobacillus amylolyticus; Lactobacillus amylophilus; Lactobacillus amylotrophicus; Lactobacillus amylovorus; Lactobacillus animalis; Lactobacillus antri; Lactobacillus apodemi; Lactobacillus aviaries; Lactobacillus bifermentans; Lactobacillus brevis; Lactobacillus buchneri; Lactobacillus camelliae; Lactobacillus casei; Lactobacillus catenaformis; Lactobacillus ceti; Lactobacillus coleohominis; Lactobacillus collinoides; Lactobacillus composti; Lactobacillus concavus; Lactobacillus coryniformis; Lactobacillus crispatus; Lactobacillus crustorum; Lactobacillus curvatus; Lactobacillus delbrueckii subsp. delbrueckii; Lactobacillus delbrueckii subsp. bulgaricus; Lactobacillus delbrueckii subsp. lactis; Lactobacillus dextrinicus; Lactobacillus diolivorans; Lactobacillus equi; Lactobacillus equigenerosi; Lactobacillus farraginis; Lactobacillus farciminis; Lactobacillus fermentum; Lactobacillus fomicalis; Lactobacillus fructivorans; Lactobacillus frumenti; Lactobacillus fuchuensis; Lactobacillus gallinarum; Lactobacillus gasseri; Lactobacillus gastricus; Lactobacillus ghanensis; Lactobacillus graminis; Lactobacillus hammesii; Lactobacillus hamster; Lactobacillus harbinensis; Lactobacillus hayakitensis; Lactobacillus helveticus; Lactobacillus hilgardii; Lactobacillus homohiochii; Lactobacillus iners; Lactobacillus ingluviei; Lactobacillus intestinalis; Lactobacillus jensenii; Lactobacillus johnsonii; Lactobacillus kalixensis; Lactobacillus kefiranofaciens; Lactobacillus kefiri; Lactobacillus kimchii; Lactobacillus kitasatonis; Lactobacillus kunkeei; Lactobacillus leichmannii; Lactobacillus lindneri; Lactobacillus malefermentans; Lactobacillus mali; Lactobacillus manihotivorans; Lactobacillus mindensis; Lactobacillus mucosae; Lactobacillus murinus; Lactobacillus nagelii; Lactobacillus namurensis; Lactobacillus nantensis; Lactobacillus oligofermentans; Lactobacillus oris; Lactobacillus panis; Lactobacillus pantheris; Lactobacillus parabrevis; Lactobacillus parabuchneri; Lactobacillus paracollinoides; Lactobacillus parafarraginis; Lactobacillus parakefiri; Lactobacillus paralimentarius; Lactobacillus paraplantarum; Lactobacillus pentosus; Lactobacillus perolens; Lactobacillus plantarum; Lactobacillus pontis; Lactobacillus psittaci; Lactobacillus rennin; Lactobacillus reuteri; Lactobacillus rhamnosus; Lactobacillus rimae; Lactobacillus rogosae; Lactobacillus rossiae; Lactobacillus ruminis; Lactobacillus saerimneri; Lactobacillus sakei; Lactobacillus salivarius; Lactobacillus sanfranciscensis; Lactobacillus satsumensis; Lactobacillus secaliphilus; Lactobacillus sharpeae; Lactobacillus siliginis; Lactobacillus spicheri; Lactobacillus suebicus; Lactobacillus thailandensis; Lactobacillus ultunensis; Lactobacillus vaccinostercus; Lactobacillus vaginalis; Lactobacillus versmoldensis; Lactobacillus vini; Lactobacillus vitulinus; Lactobacillus zeae; Lactobacillus zymae.
55. The method of any of paragraphs 35-54, wherein the cellulosic material is selected from the group consisting of corn stover, corn fiber, soybean stover, soybean fiber, rice straw, pine wood, wood chips, poplar, wheat straw, switchgrass, bagasse, green chopped whole corn, hay, alfalfa, and any combination thereof.
56. The method of paragraph 55, wherein the material is corn stover.
57. The method of any of paragraphs 35-56, wherein the pretreatment comprises chemical pretreatment.
58. The method of paragraph 57, wherein the chemical pretreatment is an alkaline chemical pretreatment.
59. The method of paragraph 58, wherein the alkaline chemical pretreatment is a treatment of calcium oxide, sodium hydroxide, ammonia, or a combination thereof.
60. The method of any of paragraphs 35-59, wherein the pretreatment comprises mechanical pretreatment.
61. The method of paragraph 60, wherein the mechanical pretreatment occurs contemporaneously with the chemical pretreatment.
62. The method of any of paragraphs 35-61, wherein the pretreatment comprises biological pretreatment.
63. The method of any of paragraphs 35-62, wherein the pretreatment comprises heat pretreatment.
64. The method of any of paragraphs 35-63, wherein the cellulosic material is incubated with the at least one microorganism under aerobic conditions.
65. The method of any of paragraphs 35-63, wherein the cellulosic material is incubated with the at least one microorganism under substantially anaerobic conditions.
66. The method of any of paragraphs 35-63, wherein the cellulosic material is incubated with the at least one microorganism under anaerobic conditions.
67. The method of any of paragraphs 35-66, wherein the protein source is an animal protein or a vegetable protein.
68. The method of paragraph 67, wherein the animal protein is selected from the group consisting of meat meal, bone meal and fish meal.
69. The method of paragraph 67, wherein the vegetable protein is a legume or cereal.
70. The method of paragraph 67, wherein the vegetable protein is selected from the group consisting of barley, cabbage, cotton seed, lupin, maize, microalgae, oat, rapeseed, rice, rye, soy bean, sunflower seed, sorghum, triticale, and wheat.
71. The method of paragraph 67, wherein the protein source is dried distillers grains with solubles.
72. The method of paragraph 67, wherein the protein source is a non-protein nitrogen source which can be utilized by a ruminant to satisfy its protein requirements, e.g., urea or ammonia.
73. The method of paragraph 67, wherein the protein source is an essential amino acid, e.g., an amino acid selected from the group consisting of phenylalanine, valine, threonine, methionine, arginine, tryptophan, histidine, isoleucine, leucine, and lysine.
74. The method of any of paragraphs 35-73, wherein the at least one enzyme is selected from the group consisting of amylases, carbohydrases, cellulases, esterases, expansin, GH61 polypeptides having cellulolytic enhancing activity, glucuronidases, hemicellulases, laccases, ligninolytic enzymes, lipases, pectinases, peroxidases, phytases, proteases, swollenins, and any combination thereof.
75. The method of paragraph 74, wherein the at least one enzyme comprises an endoglucanase, a cellobiohydrolase, and a beta-glucosidase.
76. The method of paragraph 74, wherein the at least one enzyme comprises an endoglucanase, a cellobiohydrolase, a beta-glucosidase, and a GH61 polypeptide.
77. The method of paragraph 75, wherein the at least one enzyme further comprises a xylanase.
78. The method of paragraph 75 or 76, wherein the at least one enzyme further comprises a beta-xylosidase.
79. A method for producing an animal feed comprising:

(a) pretreating a cellulosic material to separate and/or release cellulose, hemicellulose and/or lignin;

(b) treating the pretreated cellulosic material with one or more enzymes selected from the group consisting of acetylxylan esterase, alpha-L-arabinofuranosidase, beta-glucosidase, beta-xylosidase, cellobiohydrolase, cellobiose dehydrogenase, endogalactosidase, endoglucanase, ferulic acid esterase, and xylanase at a pH of 7.5-11; and

(c) adding a protein source to the pretreated cellulosic material to produce the animal feed.

wherein step (c) occurs after step (a) or (b) or simultaneously with step (b).
80. The method of paragraph 79, wherein step (c) occurs after step (a).
81. The method of paragraph 79, wherein step (c) occurs after step (b).
82. The method of paragraph 79, wherein step (c) occurs simultaneously with step (b).
83. The method of any of paragraphs 79-82, wherein the pH is in the range of 8-10.
84. The method of any of paragraphs 79-83, wherein the pretreated cellulosic material is treated with an acetylxylan esterase.
85. The method of any of paragraphs 79-84, wherein the pretreated cellulosic material is treated with an alpha-L-arabinofurnasidase.
86. The method of any of paragraphs 79-85, wherein the pretreated cellulosic material is treated with a beta-glucosidase.
87. The method of any of paragraphs 79-86, wherein the pretreated cellulosic material is treated with a beta-xylosidase.
88. The method of any of paragraphs 79-87, wherein the pretreated cellulosic material is treated with a cellobiohydrolase.
89. The method of any of paragraphs 79-88, wherein the pretreated cellulosic material is treated with a cellobiose dehydrogenase.
90. The method of any of paragraphs 79-89, wherein the pretreated cellulosic material is treated with an endogalactosidase.
91. The method of any of paragraphs 79-90, wherein the pretreated cellulosic material is treated with an endoglucanase.
92. The method of any of paragraphs 79-91, wherein the pretreated cellulosic material is treated with a ferulic acid esterase.
93. The method of any of paragraphs 79-92, wherein the pretreated cellulosic material is treated with a xylanase.
94. The method of any of paragraphs 79-93, wherein the pretreated cellulosic material is treated with each of the following enzymes acetylxylan esterase, alpha-L-arabinofuranosidase, beta-glucosidase, beta-xylosidase, cellobiohydrolase, cellobiose dehydrogenase, endogalactosidase, endoglucanase, ferulic acid esterase, and xylanase.
95. The method of any of paragraphs 79-94, wherein the cellulosic material is selected from the group consisting of corn stover, corn fiber, soybean stover, soybean fiber, rice straw, pine wood, wood chips, poplar, wheat straw, switchgrass, bagasse, green chopped whole corn, hay, alfalfa, and any combination thereof.
96. The method of paragraph 95, wherein said material is corn stover.
97. The method of any of paragraphs 79-96, wherein the pretreatment comprises chemical treatment.
98. The method of paragraph 97, wherein the chemical treatment is an alkaline chemical treatment.
99. The method of paragraph 98, wherein the alkaline chemical treatment is a treatment of calcium oxide, sodium hydroxide, ammonia, or a combination thereof.
100. The method of any of paragraphs 79-99, wherein the pretreatment comprises mechanical treatment.
101. The method of paragraph 100, wherein the mechanical treatment occurs contemporaneously with the chemical treatment.
102. The method of any of paragraphs 79-101, wherein the pretreatment comprises biological treatment.
103. The method of any of paragraphs 79-102, wherein the pretreatment comprises heat pretreatment.
104. The method of any of paragraphs 79-103, wherein the protein source is an animal protein or a vegetable protein.
105. The method of paragraph 104, wherein the animal protein is selected from the group consisting of meat meal, bone meal and fish meal.
106. The method of paragraph 104, wherein the vegetable protein is a legume or cereal.
107. The method of paragraph 104, wherein the vegetable protein is selected from the group consisting of barley, cabbage, cotton seed, lupin, maize, microalgae, oat, rapeseed, rice, rye, soy bean, sunflower seed, sorghum, triticale, and wheat.
108. The method of paragraph 104, wherein the protein source is dried distillers grains with solubles.
109. The method of paragraph 104, wherein the protein source is a non-protein nitrogen source which can be utilized by a ruminant to satisfy its protein requirements, e.g., urea or ammonia.
110. The method of paragraph 104, wherein the protein source is an essential amino acid, e.g., an amino acid selected from the group consisting of phenylalanine, valine, threonine, methionine, arginine, tryptophan, histidine, isoleucine, leucine, and lysine.
111. The method of any of paragraphs 1-110, wherein the method increases digestibility by at least 5%, e.g., at least 10%, at least 20%, at least 30%, at least 40%, at least 50, at least 60%, at least 70%, at least 80%, at least 90%, up to 100%.
112. An animal feed produced the method of any of paragraphs 1-111.
113. The animal feed of paragraph 112, further comprising at least one fat-soluble vitamin, and/or at least one water soluble vitamin, and/or at least one trace mineral, and/or at least one macro mineral.
114. The animal feed of paragraph 112 or 113, further comprising an organic acid such as ascorbic acid, citric acid, aconitic acid, malic acid, fumaric acid, succinic acid, lactic acid, malonic acid, maleic acid, tartaric acid, aspartic acid, oxalic acid, tatronic acid, oxaloacetic acid, isomalic acid, pyrocitric acid, glutaric acid, ketoglutaric acid, and mixtures thereof.
115. The animal feed of any of paragraphs 112-114, further comprising gluten protein, e.g., wheat gluten proteins, corn gluten proteins, oat gluten proteins, rye gluten proteins, rice globulin proteins, barley gluten proteins, and mixtures thereof.
116. The animal feed of any of paragraphs 112-115, further comprising a divalent metal ion, e.g., of zinc, manganese and iron.
117. The animal feed of any of paragraphs 112-116, further comprising a plant extract.
118. The animal feed of any of paragraphs 112-117, further comprising a proteinaceous feed ingredient, such as, plant and vegetable proteins, including edible grains and grain meals selected from the group consisting of soybeans, soybean meal, corn, corn meal, linseed, linseed meal, cottonseed, cottonseed meal, rapeseed, rapeseed meal, sorghum protein, and canola meal. Other examples of proteinaceous feed ingredients may include; corn or a component of corn, such as, for example, corn fiber, corn hulls, silage, ground corn, or any other portion of a corn plant; soy or a component of soy, such as, for example, soy hulls, soy silage, ground soy, or any other portion of a soy plant; wheat or any component of wheat, such as, for example, wheat fiber, wheat hulls, wheat chaff, ground wheat, wheat germ, or any other portion of a wheat plant; canola or any other portion of a canola plant, such as, for example, canola protein, canola hulls, ground canola, or any other portion of a canola plant; sunflower or a component of a sunflower plant; sorghum or a component of a sorghum plant; sugar beet or a component of a sugar beet plant; cane sugar or a component of a sugarcane plant; barley or a component of a barley plant; corn steep liquor; a waste stream from an agricultural processing facility; soy molasses; flax; peanuts; peas; oats; grasses, such as orchard grass and fescue, and alfalfa, clover used for silage or hay.
119. The animal feed of any of paragraphs 112-118, further comprising distillers dried grains (DDG) and distillers dried grains with soluble (DDGS).
120. The animal feed of any of paragraphs 112-119, further comprising at least one other enzyme selected from the group consisting of phytase (EC 3.1.3.8 or 3.1.3.26); xylanase (EC 3.2.1.8); galactanase (EC 3.2.1.89); alpha-galactosidase (EC 3.2.1.22); protease (EC 3.4.-.-), phospholipase A1 (EC 3.1.1.32); phospholipase A2 (EC 3.1.1.4); lysophospholipase (EC 3.1.1.5); phospholipase C (3.1.4.3); phospholipase D (EC 3.1.4.4); amylase such as, for example, alpha-amylase (EC 3.2.1.1); and/or beta-glucanase (EC 3.2.1.4 or EC 3.2.1.6).

1. A method for producing an animal feed comprising:
(a) pretreating a cellulosic material to separate and/or release cellulose, hemicellulose and/or lignin;
(b) inoculating said pretreated cellulosic material with at least one Bacillus strain;
(c) incubating said inoculated material with the at least one Bacillus strain; and
(d) adding a protein source to produce an animal feed additive;
wherein step (d) occurs after step (a), (b) or (c) or simultaneously with step (b) or (c).

2. A method for producing an animal feed comprising:
(a) pretreating a cellulosic material to separate and/or release cellulose, hemicellulose and/or lignin;
(b) inoculating said pretreated cellulosic material with at least one microorganism;
(c) incubating said inoculated material with the at least one microorganism;
(d) applying at least one enzyme to the pretreated cellulosic material; and
(e) adding a protein source to produce an animal feed additive;
wherein step (d) occurs after step (a), (b), (c) or (e) or simultaneously with step (b), (c) or (e) and step (e) occurs after step (a), (b), (c) or (d) or simultaneously with step (b), (c) or (d).

3. A method for producing an animal feed comprising:
(a) pretreating a cellulosic material to separate and/or release cellulose, hemicellulose and/or lignin;
(b) treating the pretreated cellulosic material with one or more enzymes selected from the group consisting of acetylxylan esterase, alpha-L-arabinofuranosidase, beta-glucosidase, beta-xylosidase, cellobiohydrolase, cellobiose dehydrogenase, endogalactosidase, endoglucanase, ferulic acid esterase, and xylanase at a pH of 7.5-11; and
(c) adding a protein source to the pretreated cellulosic material to produce the animal feed.
wherein step (c) occurs after step (a) or (b) or simultaneously with step (b).

4. (canceled)
